(19) United States
(12) Patent Application Publication
(10) Pub. No.: US 2013/0304546 A1
(43) Pub. Date: Nov. 14, 2013

(54) NOVEL SYSTEMS AND METHODS FOR OPTIMIZING PROFIT OR GROSS MARGIN BASED ON ONE OF MORE VALUES OF PROCESS PARAMETERS FOR PRODUCING BIOFUEL

(71) Applicants: Nicholas Carlin, Bay Point, CA (US); John J. McNamara, El Sobrante, CA (US); Ashish Garg, Punjab (IN); Pauravi Shah, San Francisco, CA (US); Sumer Johal, Walnut Creek, CA (US)

(72) Inventors: Nicholas Carlin, Bay Point, CA (US); John J. McNamara, El Sobrante, CA (US); Ashish Garg, Punjab (IN); Pauravi Shah, San Francisco, CA (US); Sumer Johal, Walnut Creek, CA (US)

(73) Assignee: AGNI CORPORATION (CAYMAN ISLANDS), George Town (KY)

(21) Appl. No.: 13/469,098

(22) Filed: May 11, 2012

(51) Int. Cl. G06Q 10/00

(52) U.S. Cl. 705/7.38

(57) ABSTRACT

A process for optimizing values of profit or gross margin based on process parameters used to process fuel having a desired fuel property is described. The process includes: (i) receiving a predetermined value of a first property of a fuel derived from biomass; (ii) retrieving a first different sets of values of one or more process parameters associated with a process that converts biomass to fuel, and the first different sets of values of the one or more process parameters are based on the predetermined value of the first fuel property; (iii) generating estimated values for cost or revenue associated with the first different sets of values of the one or more process parameters; and (iv) identifying, from the first different sets of values, a first set of values of one or more process parameters that approaches an optimum profit or gross margin for the process.

### FIELD OF THE INVENTION

The present invention relates to novel systems and methods for producing fuel from biomass. More particularly, the present invention relates to novel systems and methods for optimizing values of profit or gross margin based on process parameters associated with the process of producing fuel.

### BACKGROUND OF THE INVENTION

High demand for fuel and energy, and a decrease in conventional energy supplies, such as oil and natural gas, are driving exploration of renewable energy sources such as biofuels. Renewable energy sources are desirable because they are available long after conventional energy supplies have been depleted. Specifically, biomass, a resource abundantly and renewably present in nature, is the source for production of biofuels.

Biomass can be of many different types. One example of biomass is agricultural waste, often referred to as agro-waste. Agro-waste, in turn, can be of many different types. Examples of agro-waste include rice straw, sugarcane leaves and corn stover. As would be expected, certain types of agro-waste are more commonly available over other types in a geographic region, depending typically on the types of crops favored in that region. Consequently, abundance of different types of agro-waste varies from region to region.

Different types of agro-waste have different chemical constituents or different physical properties. As a result, fuel produced from one type of agro-waste has different fuel properties compared to fuel produced from another type of agro-waste. Moreover, fuel produced from one type of agro-waste commonly found in one region has different fuel properties compared to the fuel produced from the same type or another type of agro-waste commonly found in another region.

Unfortunately, current systems and processes for producing fuel from biomass suffer from drawbacks. By way of example, it is very difficult to produce fuel having specific, desirable fuel properties from diverse biomass in a commercially viable manner. Although biomass diversity spans across different regions, it is necessary to produce fuel having specific properties across those regions. For various energy-driven applications across different regions, where the need for an energy source having specific fuel properties is a must, producing fuel from diverse types of biomass does not present a commercially viable solution.

Current systems and processes, which attempt to produce fuel from biomass, do so by developing a unique system design and a unique fuel production process for a particular type of biomass. Expending such efforts in the hopes of producing fuel with specific, desirable properties is time consuming, and represents an expensive and arduous task that does not account for optimization of profit or gross margin.

What is therefore needed are novel systems and methods that harness energy from diverse types of biomass processed according to values of process parameters that optimize profit or gross margin without suffering from the drawbacks encountered by the conventional systems and processes of biomass treatment.

### SUMMARY OF THE INVENTION

In view of the foregoing, in one aspect, the present invention provides novel systems and methods for producing biofuel from one or more values of process parameters.

In one aspect, the present invention provides a process for processing biomass. The process includes: (1) receiving a predetermined value of a first property of a fuel that is derived from biomass; retrieving a first different sets of values of one or more process parameters associated with a process that converts the biomass to fuel, and the first different sets of values of the one or more process parameters are based on predetermined value of the first fuel property; (2) generating estimated values for cost or revenue associated with the first different sets of values of the one or more process parameters; (3) identifying, from the first different sets of values of said one or more process parameters, a first set of values of one or more process parameters that approaches an optimum profit or gross margin for said process; and (4) processing biomass near or at said first set of values of said one or more process parameters identified in said identifying. Preferably, generating includes the further steps of (1) determining a value of energy load required for processing biomass, for each said first different sets of values of process parameters, to produce fuel having the predetermined value of the fuel property; (2) computing a value of energy supply necessary to make available the value of the energy load; and (3) estimating costs incurred to produce the value of the energy supply. More preferably, generating includes generating values for at least one member selected from a group consisting of energy supply costs, electrical costs, fixed costs, variable costs, and biomass procurement costs.

In preferred embodiments of the present invention, the present invention includes the further steps of: (1) obtaining additional values for a first property of fuel; (2) retrieving additional of the first different sets of values for one or more process parameters associated with the process that converts biomass to fuel, and the additional of the first different sets of values for one or more said process parameters are based on the additional values of the first fuel property; (3) generating additional values for cost or revenue associated with each of the additional of the first different sets of values for one or more process parameters of the process; (4) identifying, from the first different set of values and additional values of the first different sets of values, an optimum set of values for one or more process parameters that approaches an optimum profit or gross margin for the process; and (5) processing biomass under the optimum set of values for one or more process parameters. Preferably, the first fuel property is a property selected from a group consisting of mass yield, higher heating value, fixed carbon, volatile matter, carbon content, oxygen content, hydrogen content, and final ash content. In certain embodiments, the optimum set of values provides information regarding value of second fuel property that is identified to be optimum among different values of the second fuel property, each of which corresponds to the predetermined value of the fuel property or the additional values of said first fuel property. Preferably, obtaining different values for a second property of the fuel is carried out using the predetermined value of the first fuel property and the first different sets of values of the first fuel property.

In another aspect, the present invention provides a system for processing biomass. The system includes: (1) means for receiving a predetermined value of a first property of a fuel that is derived from biomass; (2) means for retrieving a first different sets of values for one or more process parameters associated with a process that converts said biomass to said fuel, and said first different sets of values for one or more said process parameters are based on said predetermined value of said first fuel property; (3) means for generating values for cost or revenue associated with said first different sets of values for one or more process parameters of said process; (4) means for identifying, from said first different sets of values for one or more process parameters, a first set of values for one or more process parameters that approaches an optimum profit or gross margin for said process; and (5) means for processing biomass under said first set of values for one or more process parameters identified in said identifying. Preferably, the means for generating includes a microprocessor. In certain embodiments, the process of converting the biomass to fuel is carried out in a thermo-chemical reactor.

In yet another aspect, the present invention provides a system for facilitating production of fuel. The system includes (1) at least one processor; (2) at least one interface operable to provide a communication link to at least one network device; and (3) memory. The processor is operable to store in said memory a plurality of data structures. The system is operable to: (1) obtain a predetermined value of a first property of a fuel that is derived from biomass; (2) retrieve a first different sets of values for one or more process parameters associated with a process that converts said biomass to said fuel, and said first different sets of values for one or more said process parameters are based on said predetermined value of said first fuel property; (3) generate values for cost or revenue associated with said first different sets of values for one or more process parameters of said process; (4) identify, from said first different sets of values for one or more process parameters, a first set of values for one or more process parameters that approaches an optimum profit or gross margin for said process; and (5) process biomass under said first set of values for one or more process parameters identified in said identifying. Preferably, the processor is used to generate values for cost or revenue associated with the first different sets of values for one or more process parameters of the process. In preferred embodiments of the present invention, the process of converting the biomass to fuel is carried out in a thermochemical reactor.

### BRIEF DESCRIPTION OF THE DRAWINGS

FIG. 1 is a block diagram of an interactive environment, according to one embodiment of the present invention, showing different systems involved in production and sale of biomass-based fuel.

FIG. 2 is an exemplar embodiment of a Customized Fuel Analysis Server System used for implementing various aspects/features of a Fuel Production Management Facility.

FIG. 3 is a functional block diagram of a Customized Fuel Analysis Server System, in accordance with one embodiment of the present invention.

FIG. 4A is a graph of elemental content of biomass on a dry, ash-free basis, plotted against mass yield of fuel on a dry, ash-free basis, in accordance with a preferred embodiment of the present invention.

FIG. 4B is graph of elemental mass percentage of biomass on a dry, ash-free basis, plotted against mass yield of fuel on dry, ash-free basis, in accordance with a preferred embodiment of the present invention.

FIG. 5 is a graph of higher heating value for particular types of biomass or fuel plotted against carbon/oxygen ratio, in accordance with a preferred embodiment of the present invention, for particular types of biomass or fuel.

FIG. 6 is a graph of carbon/oxygen ratio for biomass or fuel plotted against volatile matter of biomass or fuel expressed as a percentage of weight on a dry, ash-free basis, in accordance with a preferred embodiment of the present invention.

FIG. 7 is a graph of volatile matter of biomass or fuel expressed as kg/100 kg of initial biomass on a dry, ash-free basis, plotted against mass yield of biomass or fuel on a dry, ash-free basis, in accordance with a preferred embodiment of the present invention.

FIG. 8 is a graph of volatile matter of biomass or fuel expressed as a percent, by weight, on a dry, ash-free basis, plotted against mass yield of biomass or fuel on a dry, ash-free basis, in accordance with a preferred embodiment of the present invention.

FIG. 9 is a graph of ash content of biomass or fuel, expressed as a percent, by weight, on a dry basis, plotted against mass yield of biomass or fuel on a dry, ash-free basis, in accordance with a preferred embodiment of the present invention.

FIG. 10 shows a flowchart of a series of steps used to determine ash content, expressed as a percent, by weight, on a dry basis, that corresponds to the value for biomass yield on a dry, ash-free basis, in accordance with a preferred embodiment of the present invention.

FIG. 11 is a graph showing a temperature profiles and plots of mass yield over a period of time, according to one embodiment of the present invention, developed during a process of fuel production from biomass that was conducted at a ramp rate of 15° C./minute.

FIG. 12 is a graph showing a temperature profiles and plots of mass yield over a period of time, according to another embodiment of the present invention, developed during a process of fuel production from biomass that was conducted at a ramp rate of 50° C./minute.

FIG. 13A is a flowchart showing certain salient steps for a process, according to one embodiment of the present invention, of producing fuel using biomass based on one or more sets of process parameters that optimize profit and/or gross margin.

FIG. 13B is a flowchart showing step 1306 of FIG. 13A carried out according to one embodiment of the present invention and for estimating costs incurred to produce energy supply or revenue generated from production of energy supply for biomass processing.

FIG. 14 is a graph showing plots of different sets of values of time and temperature of biomass processing, according to one embodiment of the present invention, that produce a fuel with a desired predetermined higher heating value.

FIG. 15 is a graph showing plots of multiple different sets of values of time and temperature of biomass processing, according to one embodiment of the present invention, that produce fuel having a range of higher heating values.

### DETAILED DESCRIPTION OF THE PREFERRED EMBODIMENTS

In the following description, numerous specific details are set forth in order to provide a thorough understanding of the present invention. It will be apparent, however, to one skilled in the art that the present invention is practiced without limitation to some or all of these specific details. In other instances, well-known process steps have not been described in detail in order to not unnecessarily obscure the invention.

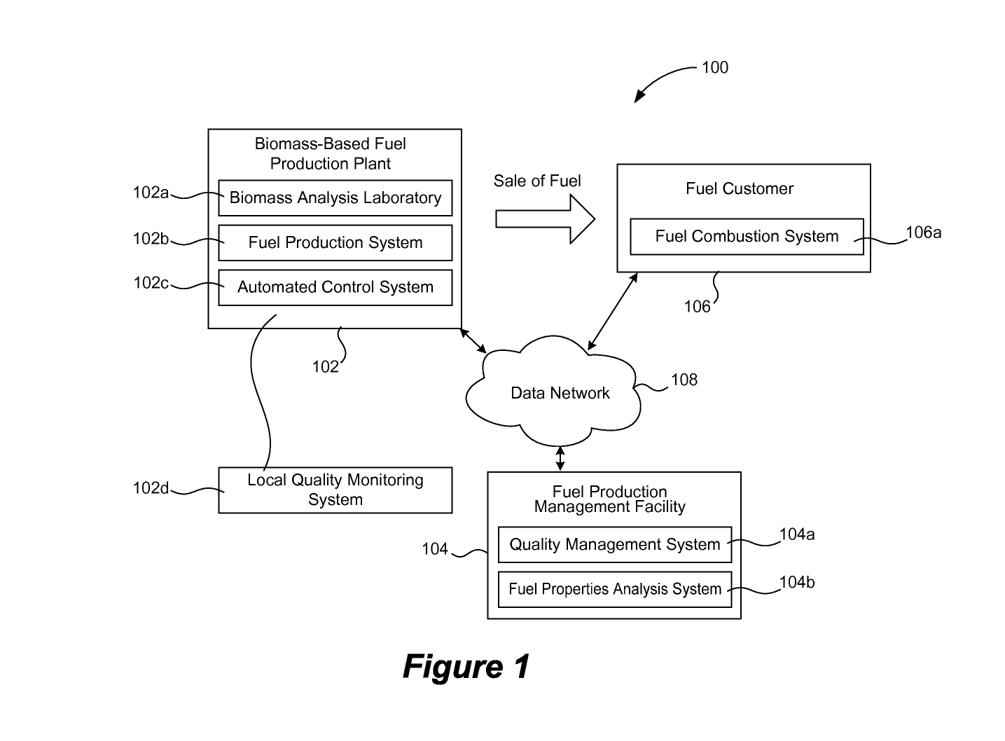

FIG. 1 is a block diagram of an interactive environment 100, according to one embodiment of the present invention, showing the different systems involved in production and sale of biomass-based fuel. In environment 100, a Biomass-Based Fuel Production Plant 102 and a Fuel Customer site 106 are communicatively coupled through a Data Network 108 to a Fuel Production Management Facility 104.

Biomass-Based Fuel Production Plant 102 produces fuel from biomass. The biomass is preferably agro-waste and more preferably, one or more different types of agro-waste. By way of example, the agro waste is at least one member selected from a group consisting of wood, guinea grass, rice straw, sugar cane leaves, cotton stalks, mustard stalks, pine needles, coffee husks, coconut husks, rice husks, mustard husks, weed straw, corn stover, sugar cane bagasse, millet stalks, pulses stalks, sweet sorghum stalks, nut shells, animal manure, guar husks, acacia totalis, Julia flora, jatropha residue, wild grass, pigeon beans, pearl millet, barley, dry chili, gran jowar, linseed, maize/corn, lentil, mung bean, sunflower, till, oil seed stalks, pulses/millets, black gram, sawan, soybean stalks, cow gram, horse gram, finger millet, turmeric, castor seed, meshta, sannhamp, and hemp. Agro-waste need not be of different types for the biomass to be considered diverse. In fact, according to the present invention, two piles of biomass from the same type of agro-waste are diverse if they have different chemical or physical properties. By way of example, if one pile of corn stover has a different average particle size than another pile of corn stover, then according to the present invention, the two piles of corn stover are diverse.

Fuel Production Plant 102 includes a Biomass Analysis Laboratory 102a, a Fuel Production System 102b, and an Automated Control System 102c. Biomass Analysis Laboratory 102a includes different components (e.g., a carbon-hydrogen-nitrogen-sulfur (“CHNS”) analyzer, a carbon-hydrogen-nitrogen-oxygen (“CHNO”) analyzer, a gaseous mass analyzer, a mass spectrometer, an infrared (“IR”) spectrometer, a thermal conductivity cell, a muffle furnace, an inert muffle furnace, a high-temperature oven, a solid fuel burner, a thermo-gravimetric analyzer, an IR spectrometer, a near infrared (“NIR”) spectrometer, an X-ray fluorescence spectrometer, a gamma ray absorber, a microwave absorber, a bomb calorimeter, a differential thermal analyzer, and a differential scanning calorimeter) to analyze various properties of biomass. A value for initial ash content is one property of the biomass that is frequently determined using an ash analysis system, such as a muffle furnace, an inert muffle furnace, a high-temperature oven, a solid fuel burner, a thermo-gravimetric analyzer, an IR spectrometer, a NIR spectrometer, an X-ray fluorescence spectrometer, a gamma ray absorber and a microwave absorber. Automated Control System 102c includes various process control equipment, which control the hardware components of a fuel production system 102b and that are involved in processing biomass into fuel. Fuel Production System 102b includes, among others, such equipment as a leaching chamber, a torrefaction chamber, a dewatering system and a drying system.

Fuel Production Management Facility 104 includes a Quality Monitoring System 104a and a fuel properties analysis system 104b. Quality Monitoring System 104a monitors one or more outputs from Fuel Production Plant 102, as a quality control measure, to ensure that biomass processing will produce fuel having requisite values for certain properties often dictated by Fuel Customer 106. Based on initial ash content of biomass provided by Biomass-Based Fuel Production Plant (preferably by Biomass Analysis Laboratory 102a) and a desired value for a particular fuel property obtained from Fuel Customer 106, Fuel Properties Analysis System 104b provides at least another fuel property to Biomass-Based Fuel Production Plant 102. Fuel Production Plant 102 uses that information to process biomass and produce a fuel having the desired properties. In preferred embodiments of the present invention, Fuel Production Management Facility 104 not only provides information regarding fuel properties to Fuel Production Plant 102, but also manages the production of fuel at that plant.

Fuel Customer 106 includes, among other things, a Fuel Combustion System 106a, which is used for burning the resulting fuel to produce energy for various applications. Depending on the application, Fuel Customer 106 specifies the desired value for a fuel property (e.g., typically higher heating value (“HHV”)). To this end, Fuel Production Management Facility 104 manages the fuel production process carried out at a Fuel Production Plant 104 to produce the fuel having the specified properties by Fuel Customer 106.

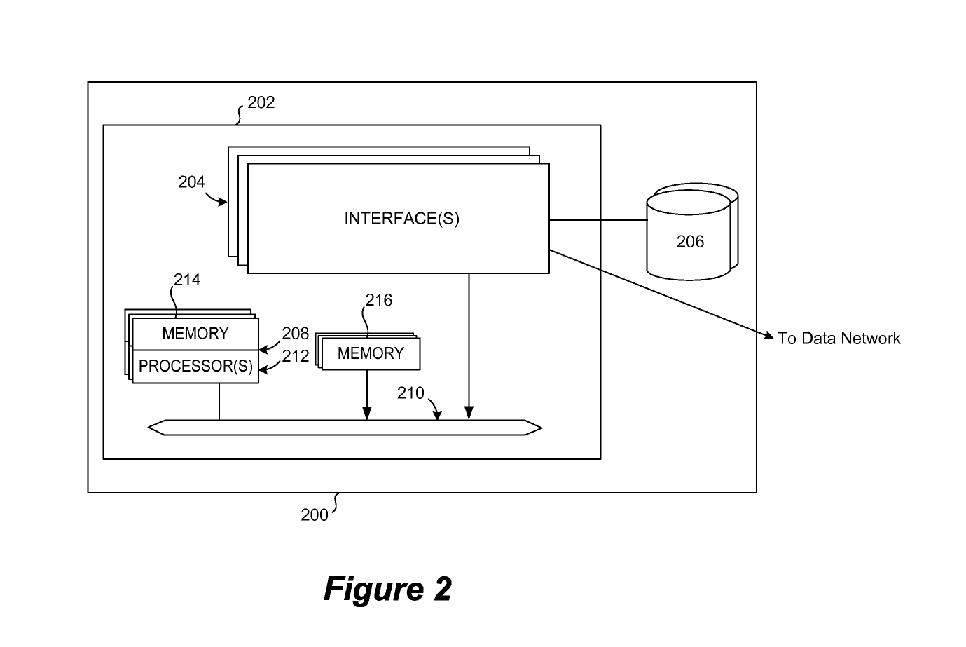

FIG. 2 illustrates an exemplar embodiment of a Customized Fuel Analysis Server System 200, which is used for implementing various aspects/features of Fuel Production Management Facility 104 described herein. In at least one embodiment, server system 200 of the present invention includes at least one network device 202, and at least one storage device 206 (such as, for example, a direct attached storage device).

According to one preferred embodiment of the present invention, network device 202 may include a master central processing unit (CPU) 208, interfaces 204 and a bus 210 (e.g., a PCI bus). When acting under the control of appropriate software or firmware, CPU 208 is responsible for implementing specific functions associated with the functions of a desired network device. For example, when configured as a server, CPU 208 is responsible for analyzing packets, encapsulating packets, forwarding packets to appropriate network devices, instantiating various types of virtual machines, virtual interfaces, virtual storage volumes, and virtual appliances. CPU 208 preferably accomplishes at least a portion of these functions under the control of software including an operating system (e.g., Linux), and any appropriate system software (such as, AppLogic™ software).

CPU 208 may include one or more processors 212, such as one or more processors from the AMD, Google (formerly Motorola), Intel and/or MIPS families of microprocessors. In an alternative embodiment, processor 212 of the present invention is specially designed hardware for controlling the operations of server system 200. In a specific embodiment, a memory 214 (such as non-volatile RAM and/or ROM) also forms part of CPU 208. However, there are many different ways in which memory could be coupled to the system. Memory block 214 is used for a variety of purposes such as, for example, caching and/or storing data, and programming instructions.

Interfaces 204 are typically provided as interface cards (sometimes referred to as “line cards”). Alternatively, one or more of interfaces 204 is provided as on-board interface controllers built into the system motherboard. Generally, they control the sending and receiving of data packets over the network and sometimes support other peripherals used with Customized Fuel Analysis Server System 200. Among the interfaces provided are FC interfaces, Ethernet interfaces, frame relay interfaces, cable interfaces, DSL interfaces, token ring interfaces, Infiniband interfaces and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, and DHEI interfaces. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, and Cellular 3G interfaces.

Generally, one or more interfaces may include ports appropriate for communication with the appropriate media. In some cases, they may also include an independent processor, and in some instances, volatile RAM. The independent processors may control such communication-intensive tasks as packet switching, media control and management. By providing separate processors for the communications intensive tasks, these interfaces allow the master microprocessor 208 to efficiently perform routing computations, network diagnostics, security functions, etc.

In at least one embodiment, some interfaces are configured or designed to allow Customized Fuel Analysis Server System 200 to communicate with other network devices associated with various data networks including, but not limited to, local area network (LANs) and/or wide area networks (WANs). Other interfaces are configured or designed to allow network device 202 to communicate with one or more directly attached storage device(s) 206.

Although the system shown in FIG. 2 illustrates one specific network device described herein, it is by no means the only network device architecture on which one or more embodiments can be implemented. For example, an architecture having a single processor that handles communications as well as routing computations may be used. Further, other types of interfaces and media could also be used with the network device.

Regardless of network device's configuration, it may employ one or more memories or memory modules (such as, for example, memory block 216, which, for example, may include random access memory (RAM)) configured to store data, program instructions for the general-purpose network operations and/or other information relating to the functionality of the various fuel analysis techniques described herein. The program instructions may control the operation of an operating system and/or one or more applications, for example. The memory or memories may also be configured to store data structures, and/or other specific non-program information described herein.

Because such information and program instructions are employed to implement the systems/methods described herein, one or more embodiments relates to machine-readable media that include program instructions, state information, etc., for performing various operations described herein. Examples of machine-readable storage media include, but are not limited to, magnetic media such as hard disks, floppy disks, magnetic tape, optical media such as CD-ROM disks, magneto-optical media such as optical disks and hardware devices that are specially configured to store and perform program instructions, such as read-only memory (ROM) and random access memory (RAM) devices. Some embodiments may also be embodied in transmission media such as, for example, a carrier wave travelling over an appropriate medium such as airwaves, optical lines and electric lines. Examples of program instructions include both machine code, such as that produced by a compiler, and files containing higher level code that is executed by the computer using an interpreter.

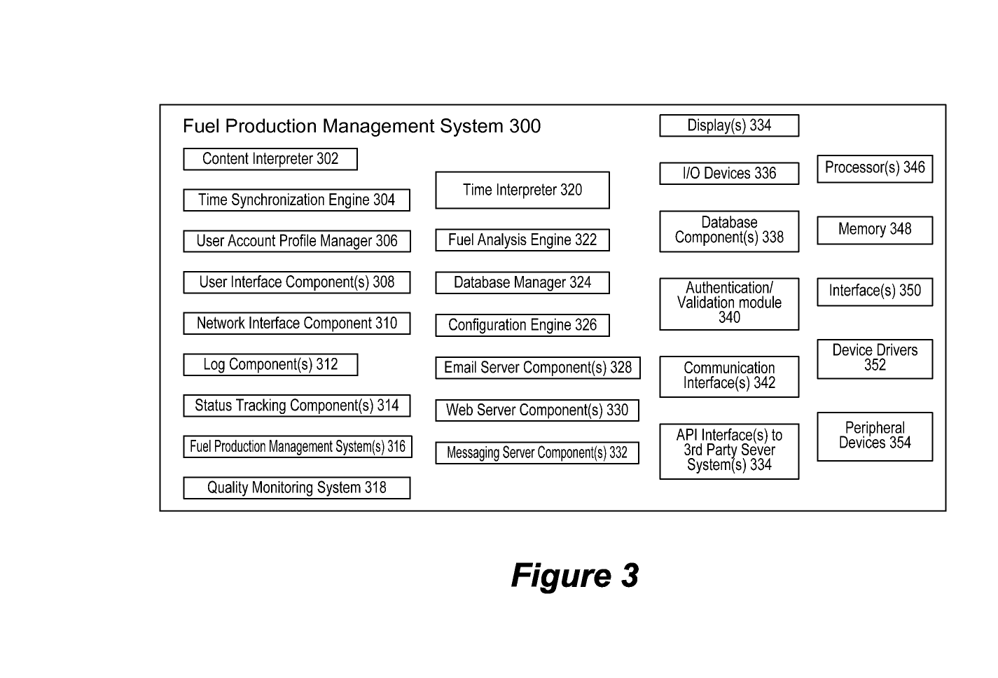

FIG. 3 illustrates an example of a functional block diagram of a Customized Fuel Analysis Server System 300, in accordance with a specific embodiment of the present invention. Customized Fuel Analysis Server Systems 200 and 300 perform similar functions, but server system 300 of FIG. 3 shows major functional blocks that are present inside the server.

Customized Fuel Analysis Server System 300 includes context interpreter 302, time synchronization engine 304, user account profile manager 306, user interface component(s) 308, network interface component 310, log component(s) 312, status tracking component(s) 314, fuel production management system(s), quality monitoring system 318, time interpreter 320, payment processing engine 322, database manager 324, configuration engine 326, email server component(s) 328, web server component(s) 330, messaging server component(s) 332, display(s) 334, I/O devices 336, database component(s) 338, authentication validation module 340, communication interface(s) 342, API interface(s) to 3^{rd} party server system(s) 344, processor(s), memory 348, interface(s) 350, device drivers 352 and peripheral devices 354.

In at least one embodiment, the Customized Fuel Analysis Server System 300 is operable to perform and/or implement various types of functions, operations, actions, and/or other features such as, for example, one or more of the following (or combinations thereof):
calculate fuel properties on a dry, ash-free basis and on a dry basis; and
based on the calculated fuel properties, manage one or more fuel production plants.

Context Interpreter 302 is operable to automatically and/or dynamically analyze contextual criteria relating to a given request for analysis, and automatically determine or identify the type of fuel analysis to be performed. According to different embodiments, examples of contextual criteria that are analyzed may include, but are not limited to, one or more of the following (or combinations thereof):
location-based criteria—e.g., geolocation of a biomass-based fuel production plant and of a fuel customer or fuel combustion site;
time-based criteria—e.g., time zone associated with the location of a biomass-based fuel production plant and of a fuel customer or fuel combustion site;
identity of a particular biomass-based fuel production plant where biomass has been or is going to be analyzed;
identity of a particular fuel customer or fuel combustion site that requires a fuel of a specified property;
profile information for both the biomass-based fuel production plant and fuel customer or fuel combustion site;
historical information for both the biomass-based fuel production plant and fuel customer or fuel combustion site (e.g., the type of biomass a particular fuel production plant available to it during a certain season of the year); and
recent production activities by a fuel production plant and recent purchase activities by a fuel customer.

For example, in at least one embodiment, the Customized Fuel Analysis Server System 300 of the present invention could collect trend data on purchasing behavior project how much fuel a particular fuel customer would be purchasing during an upcoming season.

Time Synchronization Engine 304 is operable to manage universal time synchronization (e.g., via NTP and/or GPS). User Account Profile Manager 306 is operable to manage profiles information for both the biomass-based fuel production plant and fuel customer or fuel combustion site. User Interface Component(s) 308 is operable to manage interface component (e.g., interfaces 204 of FIG. 2). Network interface component 310 is operable to manage those interfaces 204 that interface with the network. Log Component(s) 312 is operable to generate and manage fuel analysis history logs, system errors, and connections from APIs. Status Tracking Component(s) 314 is operable to automatically and/or dynamically determine, assign, and/or report updated requests for fuel analysis, and provide status information based, for example, on the state of the request. In at least one embodiment of the present invention, the status of a given request is reported as one or more of the following (or combinations thereof): Completed, Incomplete, Pending, Invalid, Error, Declined, and Accepted. Fuel Production Management Systems 316 is operable to manage a fuel production plant (e.g., Fuel Production System 102b in a Fuel Production Plant 102 of FIG. 1). Quality Monitoring System 318 operates in a manner similar to Quality Monitoring System 104a of FIG. 1 described herein.

Time Interpreter 320 is operable to automatically and/or dynamically modify or change identifier activation and expiration time(s) based on various criteria such as, for example, time, location, or request status. Fuel Analysis Engine 322 is operable to handle various types of request processing tasks such as, for example, one or more of the following (or combinations thereof): identifying/determining request type and associating databases information to identifiers. Database Manager 324 is operable to handle various types of tasks relating to database updating, database management and database access. In at least one embodiment, the Database Manager is operable to manage TISS databases. Configuration Engine 326 is operable to determine and handle configuration of various customized configuration parameters for one or more devices, component(s), system(s), process(es), etc. Email server component(s) 328 is configured or designed to provide various functions and operations relating to email activities and communications. By way of example, with reference to FIG. 1, information about the biomass from Biomass-Based Fuel Production Plant 102 and/or information about fuel property from Fuel Customer 106 is provided to Fuel Production Management Facility 104 by email. Web server component(s) 330 is configured or designed to provide various functions and operations relating to web server activities and communications. Messaging server component(s) 332 is configured or designed to provide various functions and operations relating to text messaging and/or other social network messaging activities and/or communications. Social networking may be used in the context of present invention in many ways, e.g., tracking type and/or amount of biomass available from particular suppliers, establishing a bidding platform for purchase of biomass and/or fuel.

Display(s) 334 is operable to handle various tasks relating to displaying information on a computer screen, for example. I/O Device(s) 336 is operable to handle various tasks that require input and output devices, such as keyboards, mouse and computer display screens. Database Manager 338 is configured or designed to provide various functions and operating relating to management of a database. Authentication/Validation Component(s) 340 (password, software/hardware info, SSL certificates) which, for example, is operable to perform various types of authentication/validation tasks such as:
verifying/authenticating devices;
verifying passwords, passcodes, SSL certificates, biometric identification;
information, and/or other types of security-related information; and
verifying/validating activation and/or expiration times.

In one implementation, the Authentication/Validation Component(s) is adapted to determine and/or authenticate the identity of the current user or owner of the mobile client system. For example, in one embodiment of the present invention, the current user is required to perform a log-in process at the mobile client system in order to access one or more features. In some embodiments, the mobile client system may include biometric security components, which is operable to validate and/or authenticate the identity of a user by reading or scanning the user's biometric information (e.g., fingerprints, face, voice, and eye/iris). In at least one implementation, various security features is incorporated into the mobile client system to prevent unauthorized users from accessing confidential or sensitive information.

Communication Interface(s) 342 is operable to manage interface for communication applications, such as email and instant messaging. API Interface(s) to 3rd Party Server System(s) 344 is operable to facilitate and manage communications and transactions with API Interface(s) to 3rd Party Server System(s).

In at least one embodiment of the present invention, processor(s) 346 may include one or more commonly known CPUs that are deployed in many of today's consumer electronic devices, such as, for example, CPUs or processors from the Google (formerly Motorola) and/or the Intel family of microprocessors. In an alternative embodiment of the present invention, at least one processor is specially designed hardware for controlling the operations of the mobile client system. In a specific embodiment, a memory (such as non-volatile RAM and/or ROM) also forms part of CPU. When acting under the control of appropriate software or firmware, the CPU is responsible for implementing specific functions associated with the functions of a desired network device. The CPU preferably accomplishes all these functions under the control of software including an operating system, and any appropriate applications software.

Memory 348 may include volatile memory (e.g., RAM), non-volatile memory (e.g., disk memory, FLASH memory, and EPROMs), unalterable memory, and/or other types of memory. In at least one implementation of the present invention, memory 348 may include functionality similar to at least a portion of functionality implemented by one or more commonly known memory devices such as those described herein and/or generally known to one having ordinary skill in the art. According to different embodiments of the present invention, one or more memories or memory modules (e.g., memory blocks) are configured or designed to store data, program instructions for the functional operations of the mobile client system and/or other information relating to the functionality of the various fuel analysis techniques described herein. The program instructions may control the operation of an operating system and/or one or more applications, for example. The memory or memories may also be configured to store data structures, metadata, identifier information/images, and/or information/data relating to other features/functions described herein. Because such information and program instructions is employed to implement at least a portion of the systems located at Fuel Production Management Facility 104 described herein, various aspects described herein is implemented using machine-readable media that include program instructions, and state information.

Interface(s) 350 include wired interfaces and/or wireless interfaces. In at least one implementation of the present invention, interface(s) 350 include functionality similar to at least a portion of functionality implemented by one or more computer system interfaces such as those described herein (e.g., see Interfaces 204 of FIG. 2) and/or generally known to one having ordinary skill in the art. In at least one embodiment of the present invention, Device Driver(s) 352 include functionality similar to at least a portion of functionality implemented by one or more computer system driver devices such as those described herein and/or generally known to one having ordinary skill in the art. Peripheral Devices 354 include various peripheral devices, such as printers, image scanners, tape drives, microphones, loudspeakers, webcams, and digital cameras.

Systems and method of the present invention provide, among other things, certain empirical correlations that are independent of the type of biomass. These correlations, either used individually or collectively, provide one or more fuel properties preferably to a biomass-based fuel production plant.

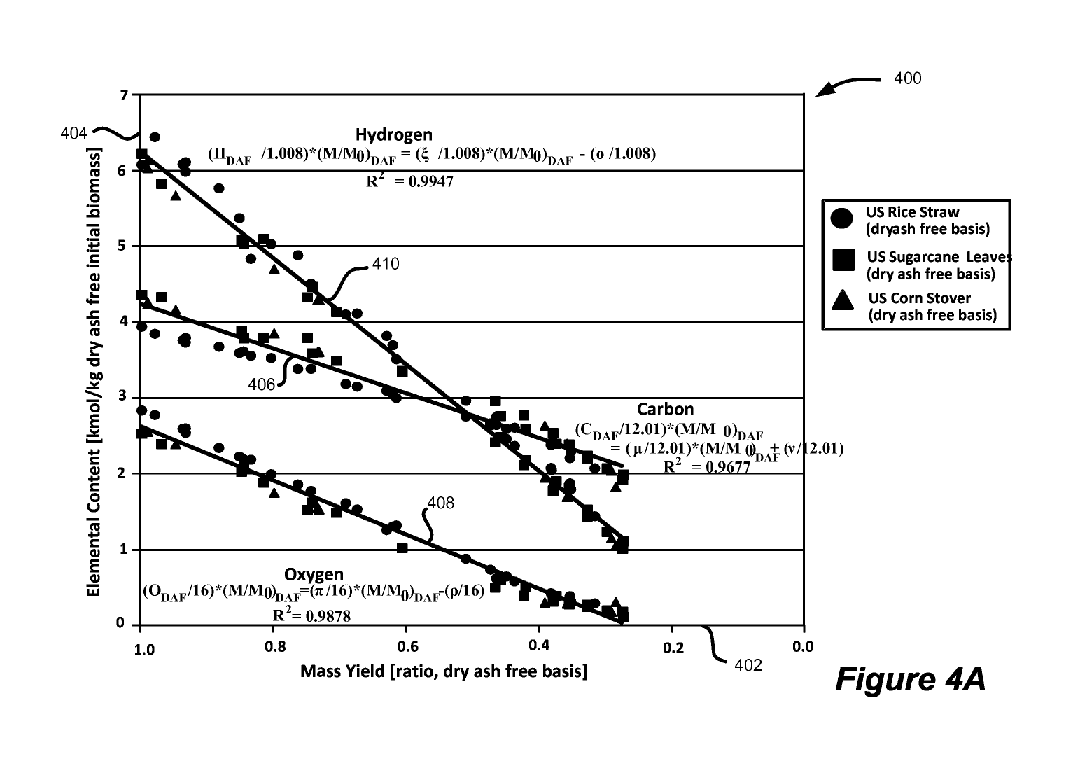

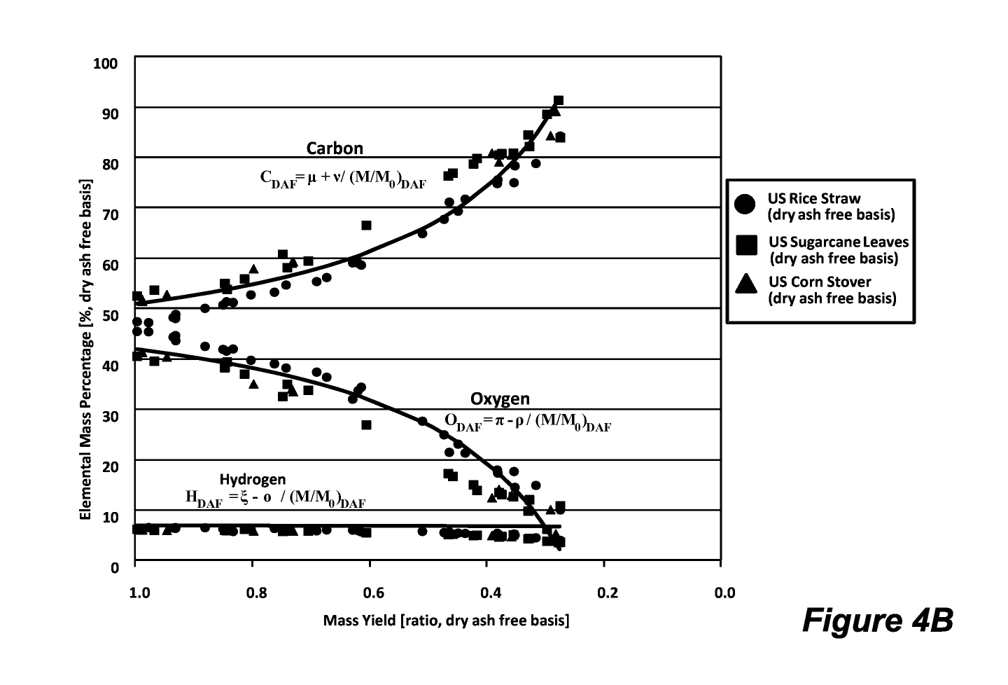

FIG. 4A shows a graph 400 where amounts of elemental content, such as carbon (C), hydrogen (H) and oxygen (O), found in biomass on a dry, ash-free (“DAF”) basis, are plotted on a Y-axis (denoted by reference numeral 404) and values of mass yield of fuel on a DAF basis are plotted on an X-axis (denoted by 402). The amount of elemental content is expressed in units of kmol/kg of DAF initial biomass. Mass yield, defined as a ratio of mass of fuel (M) to an initial mass of biomass (Mₒ), is a dimensionless quantity. Both M and Mₒ have units of mass.

In FIG. 4A, values for mass yield on a DAF basis are presented beginning with a value of 1.0 at the origin and then gradually decreasing to a value of 0.0 on the other end of X-axis. As biomass is processed to produce fuel, value of M decreases because the mass of fuel depletes over the processing time. Given that value of Mₒ is a constant, the yield is shown in FIG. 4A to decrease over a period of time. Those skilled in the art will appreciate that although the yield is shown to decrease, the energy density of the fuel increases over the processing time. In other words, although yield of fuel decreases over a period of time when biomass is subject to processing, there is an increase in yield of fuel having high energy density values over the same period of time. For sake of simplicity, values plotted on Y-axis 404 may be thought of as providing information on weight loss of biomass sample that is being converted to fuel.

FIG. 4A shows results for elemental content in diverse types of biomass, i.e., U.S. rice straw, U.S. sugarcane leaves, and U.S. corn stover. The amount of elemental content in the initial biomass may be measured using at least one member selected from a group consisting of a CHNS analyzer, a CHNO analyzer, a gaseous mass analyzer, a mass spectrometer, an IR spectrometer, and a thermal conductivity cell. By way of example, to arrive at the elemental contents shown in FIG. 4A, a Leco TruSpec Analyzer, commercially available from LECO Corporation, St. Joseph, Mich.

In FIG. 4A, yield, M/Mₒ was computed by measuring both M and Mₒ. By way of example, about 20 grams of each type of biomass was thermochemically treated at different times and temperatures in a GCF1300 Inert Gas Furnace, commercially available from Across International of Berkeley Heights, N.J. As a result, a value for Mₒ was ascertained before treating the different types of biomass. Mass yield was measured for each thermochemical experiment (i.e., each type of biomass was weighed before and after the thermochemical treatment). This direct measurement of M and Mₒ, however, provided values on an as-received basis (i.e., the values reflect the presence of ash and moisture). For the data plotted in FIG. 4A (as well as FIGS. 4B, 7, 8, 9, 11 and 12), which show values on a dry, ash-free basis, samples of the initial biomass and the resulting thermochemically treated samples were dried, ashed and weighed again after each drying and ashing step in a Leco TGA 701, which is commercially available from LECO Corporation of St. Joseph, Mich. Such steps were implemented to determine the amount of moisture and ash in both the biomass and the thermochemically treated samples. The measurements for both M and Mₒ were then corrected for moisture and ash to produce values on a dry, ash-free basis. Thus, the ratio of the corrected values of M and Mₒ is the mass yield on a dry, ash-free basis shown in FIGS. 4A, 4B, 7, 8, 9, 11 and 12, which are discussed in greater detail below. The above-described steps were not only carried out for all mass yield measurements described herein, but was also carried out for obtaining values of other fuel properties described here, i.e., higher heating value, volatile matter, carbon content, oxygen content and hydrogen content. Other equipment used to obtain values for such fuel properties is provided below in greater detail. It is noteworthy that measurement of other fuel properties, such as the measurement of mass yield, is provided on an as-received basis, which refers to dry basis. To provide corresponding values for these fuel properties on a dry, ash-free basis, ash and moisture content are measured and accounted for using the above-mention LECO TGA 701.

After the results obtained from measurements of elemental content and yield were plotted in FIG. 4A, linear regression analysis was conducted. A linear relationship for each of carbon 406, oxygen 408, and hydrogen 410 was obtained.

Linear relationship for carbon 406 is expressed by the following equation:

(C_{DAF}/12.01)*(M/M₀)_{DAF}=(μ/12.01)*(M/M₀)_{DAF}+(ν/12.01) (Equation 1)

In Equation 1, μ and ν are empirically derived constants. Furthermore, μ is a value that is between about 20 and 50, preferably between about 35 and about 36, and ν is a value that is between about 8 and about 25, preferably between about 15 and about 16. As explained above, C_{DAF} and (M/M₀)_{DAF} in Equation 1 refer to carbon and mass yield on a DAF basis, respectively.

Linear relationships for oxygen 408 and for hydrogen 410 were also similarly developed and are expressed in a similar manner below. Linear relationship for oxygen 408 is expressed by the following equation:

(O_{DAF}/16)*(M/M₀)_{DAF}=(π/16)*(M/M₀)_{DAF}−(ρ/16) (Equation 2)

In Equation 2, π is a value that is between about 30 and about 70, preferably between about 57 and about 58 and ρ is a value that is between about 8 and about 25, preferably between about 15 and about 16.

Linear relationship for hydrogen 410 is expressed as:

(H_{DAF}/1.008)*(M/M₀)_{DAF}=(ξ/1.008)*(M/M₀)_{DAF}−(o/1.008) (Equation 3)

In Equation 3, ε is a value that is between about 2 and about 12, preferably between about 6 and about 8, and o is a value that is between about 0.2 and about 1, preferably between about 0.7 and about 0.8.

For each linear relationships 406, 408 and 410 shown in FIG. 4A, a root mean square value, R² value, also known in the art as a “goodness of fit,” was computed to obtain insight into the strength of the correlation expressed in Equations 1, 2, and 3. For Equations 1-3, R² is about 0.97, 0.99 and 0.99, respectively. According to the present invention, regardless of the type of agro-waste or, in the alternative, type of biomass used to produce fuel, there is a strong correlation between the amount of each element (i.e., carbon, hydrogen and oxygen) and mass yield in the DAF regime. In other words, the present invention has established that in the DAF regime, the amount of elemental content and the mass yield enjoy a strong correlation independent of the type of underlying agro-waste or biomass used to produce fuel. This is particularly of interest because in the dry basis regime, in which most of the fuel specifications are provided and transactions for purchase of are carried out, such correlations between elemental content and mass yield simply do not exist.

FIG. 4B shows a graph similar to graph 400 of FIG. 4A where data points to arrive at the plots shown in FIG. 4B were obtained in a manner similar to those obtained to generate the plots shown in FIG. 4A, except the Y-axis in FIG. 4B shows values for elemental mass percentage having units of percent (%) on a DAF basis. Instead of all linear relationships as shown in FIG. 4A, FIG. 4B shows certain non-linear relationships. From the plots for carbon, oxygen, and hydrogen shown in FIG. 4B, the following correlations are derived and correspond to Equations 1-3, respectively:

C_{DAF}=μ+ν/(M/M₀)_{DAF} (Equation 4)

H_{DAF}=ξ−o/(M/M₀)_{DAF} (Equation 5)

O_{DAF}=π−ρ/(M/M₀)_{DAF} (Equation 6)

In Equations 4, 5 and 6, the variables (i.e., C_{DAF}, H_{DAF}, O_{DAF} and M/M₀) are the same as those described in Equations 1-3. Similarly, constants, μ, ν, ξ, o, π and ρ have the same values in Equations 4-6 as they do in Equations 1-3.

Equations 1-3, which are based on normalized values of elemental content (i.e., value of elemental content is multiplied by yield, M/M₀), represent a preferred embodiment of the present invention over Equations 4-6 because it is easier to fit a straight line to experimental data and achieve equations that show a strong correlation between the elemental content and mass yield in the DAF regime.

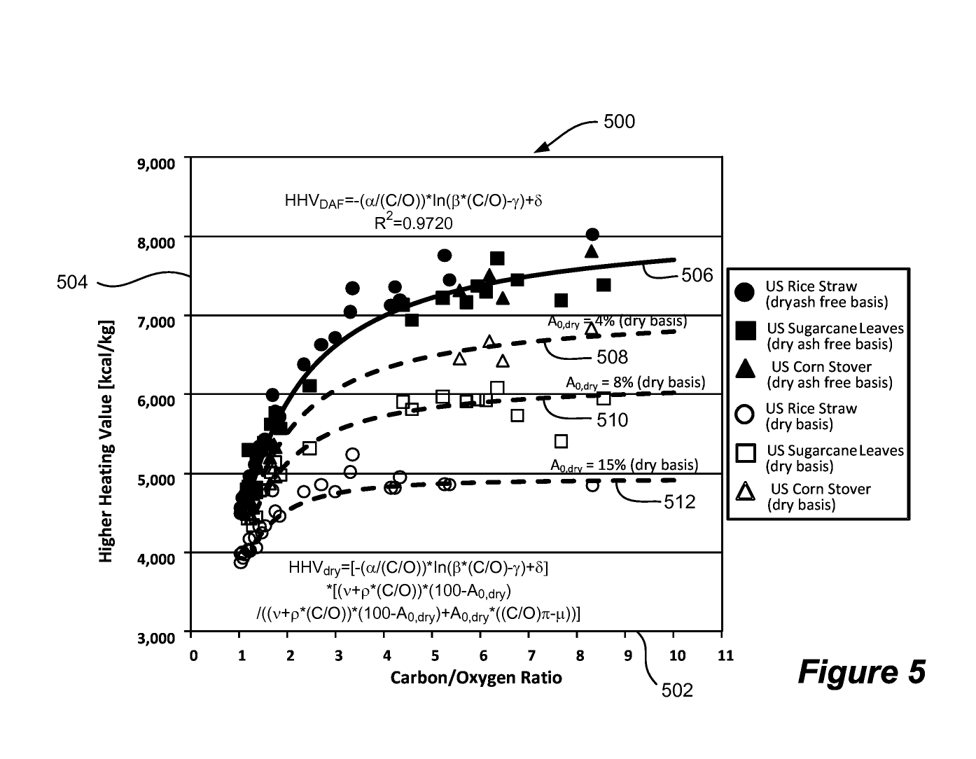

FIG. 5 shows a graph 500 where an HHV for a particular biomass (i.e., U.S. rice straw, U.S. sugarcane leaves or U.S. corn stover) is plotted on a Y-axis (denoted by 504) and a ratio of amount of carbon to amount of oxygen (represented by “C/O”) present in biomass is plotted on an X-axis (denoted by 502). HHV is expressed in units of kcal/kg of fuel and represents the amount of heat produced by the complete combustion of a unit quantity of fuel. Although values of amount of carbon and of oxygen may have any suitable units that convey an amount of element contained in biomass, in preferred embodiments of the present invention, carbon and oxygen have units of percent (%), by weight.

In FIG. 5, HHV values are presented on a DAF basis in a plot 506, and presented on a dry basis in plots 508, 510 and 512. Those skilled in the art will recognize that C/O is a dimensionless quantity, and it does not matter whether the ratio is expressed on a DAF basis or on a dry basis, because in either basis the ratio would have the same value. C/O is obtained by computing the ratio of the amount of carbon to the amount of oxygen, where the amounts were determined using the techniques described in connection with FIG. 4A.

As explained below, values of HHV on a DAF basis were calculated from measured values of HHV on a dry basis. In one embodiment of the present invention, values of HHV on a dry basis are obtained measured using at least one member selected from a group consisting of a bomb calorimeter, a differential thermal analyzer (DTA), and a differential scanning calorimeter (DSC). To arrive at values of HHV on a dry basis for developing the correlations of the present invention, LECO AC600 Bomb calorimeter, which is commercially available from LECO Corporation of St. Joseph, Mich., was used.

The present invention recognizes that to obtain values of HHV on a DAF basis from measured values of HHV on a dry basis, preferred embodiments of the present invention require knowledge of amounts of ash content on a dry basis (represented by “A_{dry}” in Equation 7 below) in the fuel, which is ultimately produced after processing of biomass. Knowledge of A_{dry}, in turn, preferably requires measuring the amounts of initial ash content present in the unprocessed biomass.

For each type of biomass, initial ash content (represented in Equations 7 and 9 as “A_{o,dry}”) may be measured using at least one member selected from a group consisting of a muffle furnace, an inert muffle furnace, a high temperature oven, a solid fuel burner, a thermo-gravimetric analyzer, an infrared (“IR”) spectrometer, a near infrared (“NIR”) spectrometer, a gamma ray absorber, an X-ray fluorescence spectrometer and a microwave absorber.

To measure the amount of initial ash content of the biomass and arrive at the correlation presented in FIG. 5, the above-mentioned LECO TGA 701 analyzer was used.

From known amounts of initial ash content of biomass (i.e., A_{o,dry}) and known values of mass yield on a DAF basis (i.e., (M/M₀)_{DAF}), an amount of ash content on a dry basis (A_{dry}) in the fuel is calculated according to the following expression:

A_{dry}=100/(((M/M₀)_{DAF}*(100−A_{0,dry})/A_{0,dry})+1) (Equation 7)

Using A_{dry} and Equation 13, values of HHV on a dry basis are converted to values for that on a DAF basis. Plot 506 of FIG. 5 was developed using values of HHV on a DAF basis, and values of C/O. By performing a curve-fitting analysis on plot 506, the present invention provides the following correlation:

HHV_{DAF}=−(α/(C/O))*ln(β*(C/O)−γ)+δ (Equation 8)

In Equation 7, “HHV_{DAF}” represents HHV on a DAF basis, and α is a value that is between about 200 and about 300 and preferably between about 260 and 261, β is a value that is between about 1×10⁷ and about 1×10⁸ and preferably between about 5×10⁷ and about 6×10⁷, γ is a value that is between about 1×10⁷ and about 1×10⁸ and preferably between about 5×10⁷ and about 6×10⁷, and δ is a value that is between about 7000 and about 9000 and preferably between about 8200 and 8300.

Similarly, using values of HHV on a dry basis (represented below as (“HHV)_{dry}”), each of plots 508, 510 and 512 are expressed as:

HHV_{dry}=[−(α/(C/O))*ln(β*(C/O)−γ)+δ]*[(ν+ρ*(C/O))*(100−A_{0,dry})/((ν+ρ*(C/O))*(100−A_{0,dry})+A_{0,dry}*((C/O)π−μ))] (Equation 9)

In Equation 9, α, β, γ and δ have the same values as shown above with respect to Equation 8. Furthermore, ν is a value that is between about 5 and about 25 and preferably between about 15 and about 16, ρ is a value that is between about 8 and about 25 and preferably between about 15 and about 16, π is a value that is between about 30 and about 70 and preferably between about 57 and about 58, and μ is a value that is between about 20 and about 50 and preferably between about 35 and about 36.

As shown by plots 508, 510 and 512 in FIG. 5, the correlation between HHV and C/O in the dry basis regime depends on the initial ash content of the biomass. For example, the particular batches of U.S. corn stover, U.S. sugarcane leaves, and U.S. rice straw that were tested each have an initial ash content of 4%, 8% and 15%, respectively. Thus, as the ash contents vary, so too does the correlation between (HHV)_{dry} and C/O. Moreover, as the amount of initial ash content in biomass increases, lower values of HHV are realized at different values of C/O.

In the DAF regime, the present invention has surprisingly and unexpectedly found this not to hold true. According to Equation 7 and plot 506 in FIG. 5, in the DAF regime, there exists a strong correlation (i.e., value of R² for plot 506 is about 0.97) between values of HHV and C/O that is independent of biomass type. Stated another way, the present invention establishes that, regardless of the type of biomass used for producing fuel, values of HHV and C/O enjoy a strong correlation in the DAF regime.

By way of example, if a Fuel Customer 106 of FIG. 1 specifies a desired value for (HHV)_{dry}, then according to the present invention using the inventive correlation presented in Equation 8 in conjunction with Equations 7 and 13, a corresponding value for C/O is obtained. Equation 8 is similarly used to obtain a value for HHV_{DAF} if a value for C/O is provided. If necessary, using Equation 7, values for HHV_{DAF} are converted to HHV_{dry}.

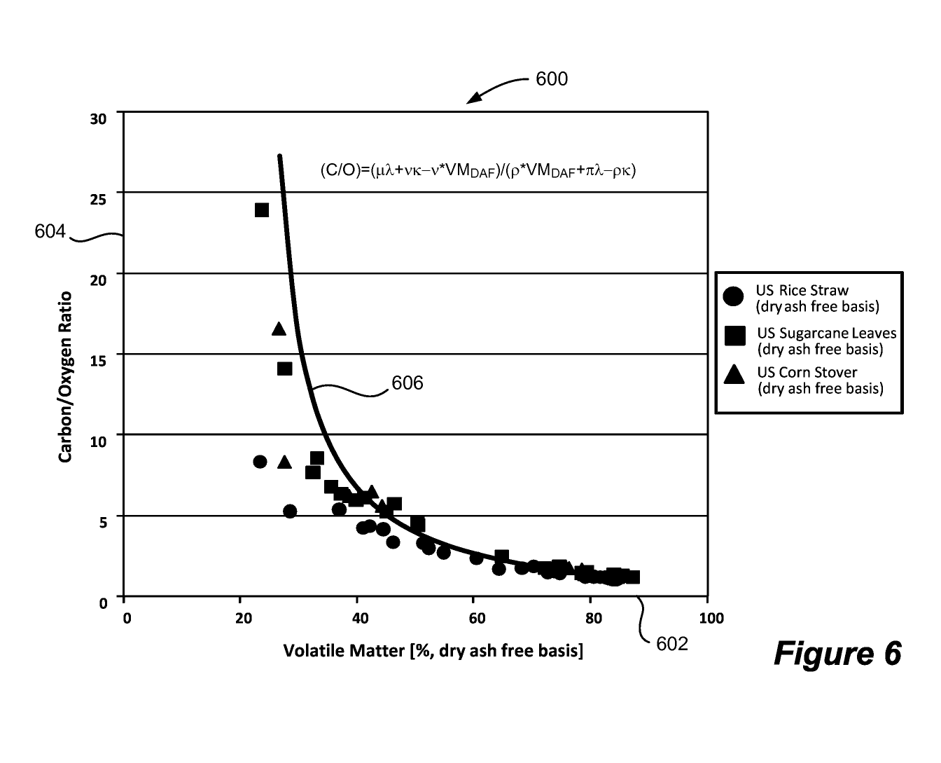

FIG. 6 shows a graph 600 where values for C/O are plotted on a Y-axis (denoted by 604), and amounts of volatile matter on a DAF basis are plotted on an X-axis (denoted by 602). Values for C/O shown in FIG. 6 are similar to the values presented for the ratio in FIG. 5, and are obtained in a manner similar to that described for the ratio in connection with FIG. 5.

Amount of volatile matter is expressed in units of percent (%), by weight. For each type of biomass, the amount of volatile matter on a DAF basis (represented in Equation 10 below as “VM_{DAF}”) may be determined using at least one member selected from a group consisting of a muffle furnace, an inert muffle furnace, a high temperature oven, a solid fuel burner, a thermo-gravimetric analyzer, an IR spectrometer, a NIR spectrometer, a gamma ray absorber and a microwave absorber. To arrive at the amount of volatile matter of the biomass presented in FIG. 6, the above-mentioned LECO TGA 701 analyzer was used.

A plot 606 was obtained using amounts of volatile matter on a DAF basis and corresponding values of C/O. As shown in FIG. 6, by performing a curve-fitting analysis on plot 606, the present invention provides the following correlation:

(C/O)=(μλ+νκ−ν*VM_{DAF})/(ρ*VM_{DAF}+πλ−ρκ) (Equation 10)

In Equation 10, ν, π, ρ and μ have the same values as in Equation 9. Furthermore, κ has a value that is between about 80 and about 120 and preferably between about 107 and about 108, and λ has a value that is between about 10 and about 35 and preferably between about 22 and about 23.

It is clear from FIG. 6 that regardless of the type of biomass used to produce fuel, the present invention provides a strong correlation between values of C/O and VM_{DAF}. Thus, for any type of biomass, if a value for C/O is known, a value for VM_{DAF} may be obtained using Equation 10. The converse is also true, i.e., for a known value of VM_{DAF} for any type of biomass, a value for C/O may be obtained using Equation 10.

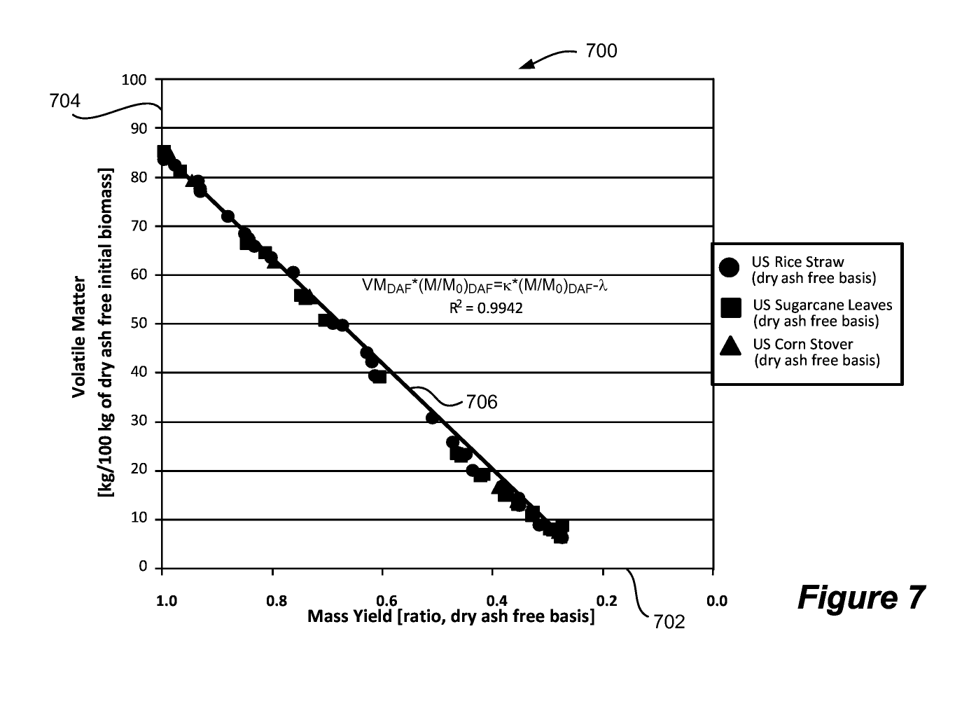

FIG. 7 shows a graph 700 in which amounts of VM_{DAF} are plotted on a Y-axis (denoted by 704) and values for mass yield on a DAF basis, i.e., (M/Mₒ)_{DAF}, are plotted on an X-axis (denoted by 702). Values for (M/Mₒ)_{DAF} shown in FIG. 7 are similar to the values presented for the ratio in FIG. 4A, and are obtained in a manner similar to that described for the ratio in connection with FIG. 4A and to develop Equations 1-6.

Amount of VM_{DAF} present in the biomass is expressed in units of kg of volatile matter/100 kg of dry, ash-free unprocessed biomass. For each type of biomass, amount of volatile matter shown in FIG. 7 is obtained in a manner similar to that described for Equation 10, except the values along the Y-axis were normalized by multiplying the obtained volatile matter values with values for mass yield, M/Mₒ.

As shown in FIG. 7, a plot 706 was developed using amounts of volatile matter as discussed above and corresponding values of mass yield on a DAF basis (represented as “(M/Mₒ)_{DAF}”). By performing a curve-fitting analysis on plot 706, the present invention provides the following correlation:

VM_{DAF}*(M/M_{O})_{DAF}=κ*(M/M₀)_{DAF}−λ (Equation 11)

In Equation 11, constants κ and λ have the same values and preferred values as described in connection with Equation 10.

As with other correlations provided by the present invention, it is clear from FIG. 7 that regardless of the type of biomass used to produce fuel, the present invention provides a strong correlation between values of VM_{DAF}. Thus, for any type of biomass, if a value for VM_{DAF} is known, a value for (M/Mₒ)_{DAF} may be obtained using Equation 11. The converse is also true, i.e., for a known value of (M/Mₒ)_{DAF} for any type of biomass, a value for VM_{DAF} may be obtained using Equation 11.

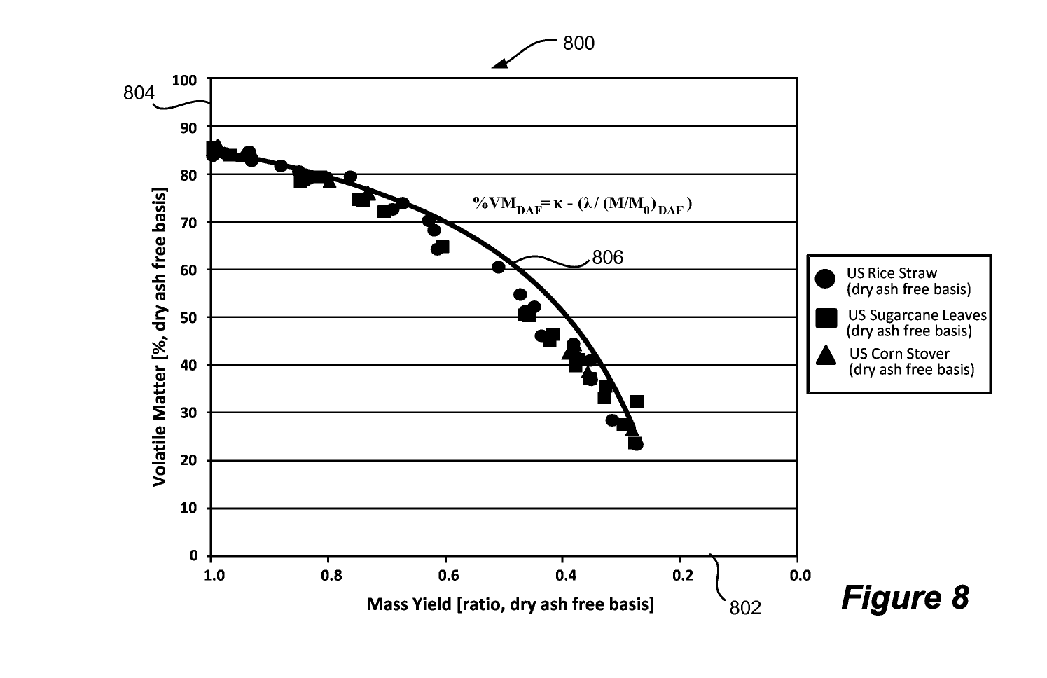

FIG. 8 shows a graph 800 similar to graph 700 of FIG. 7, where data points to arrive at the plots shown in FIG. 8 were obtained in a manner similar to those obtained to generate the plots shown in FIG. 7, except the Y-axis in FIG. 8 shows values for volatile matter having units of percent (%) on a DAF basis. Values of volatile matter in FIG. 8 were not normalized as they are in FIG. 7. A plot 806 was developed using values of VM_{DAF} and (M/Mₒ)_{DAF}. A curve fitting-analysis was performed on plot 806. Accordingly, the present invention provides the following correlation for VM_{DAF} and (M/Mₒ)_{DAF}:

VM_{DAF}=κ−(λ/(M/M₀)_{DAF}) (Equation 12)

In Equations 12, constants κ and λ have the same values and preferred values, as described for Equations 10 and 11. Equation 11, which is based on normalized values of volatile matter on a DAF basis, represents a preferred embodiment of the present invention over Equation 12 because it is easier to fit a straight line to experimental data and achieve an equation that shows a strong correlation (according to FIG. 7, R² is about 0.99 for Equation 11) between values for volatile matter and mass yield in the DAF regime.

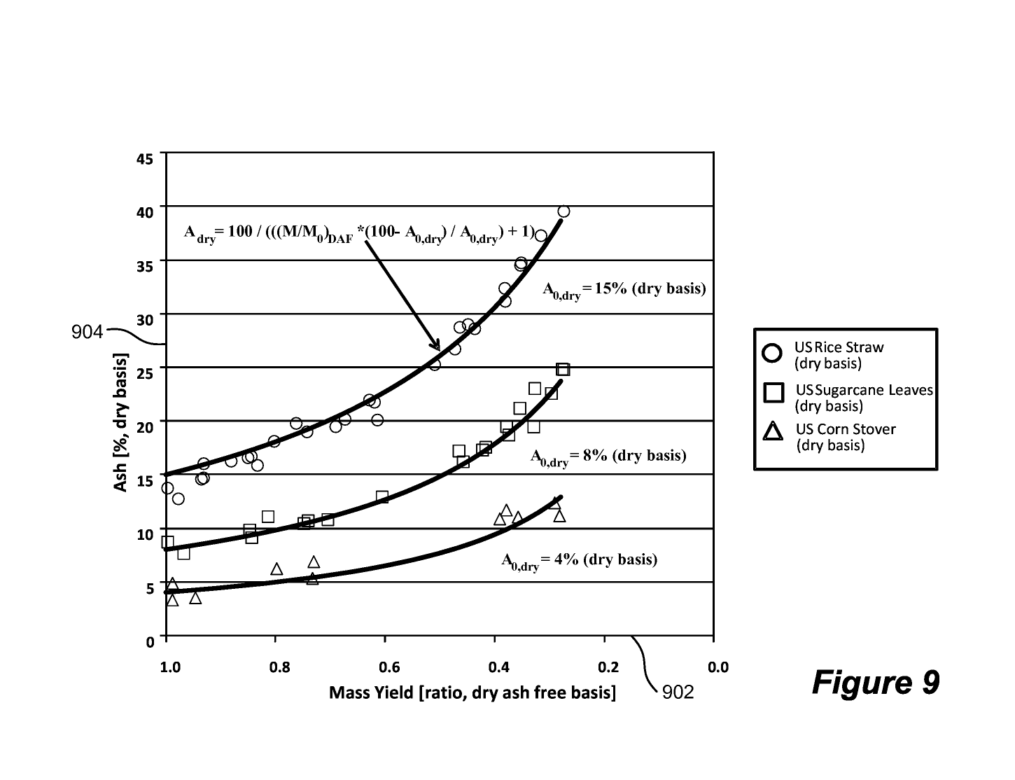

FIG. 9 shows values of ash content as a percent (%), by weight, on a dry basis, plotted on a Y-axis (denoted by 904), and values of (M/M₀)_{DAF} are plotted on an X-axis (denoted by 902). Values for ash content and mass yield were obtained using techniques described above, and plots 906, 908 and 910 were developed as shown in FIG. 9. Each of plots 906, 908 and 910 are associated with a particular type of biomass. Following a curve-fitting analysis on plots 906, 908 and 910, the present invention recognizes that the correlation presented in Equation 7 is satisfied.

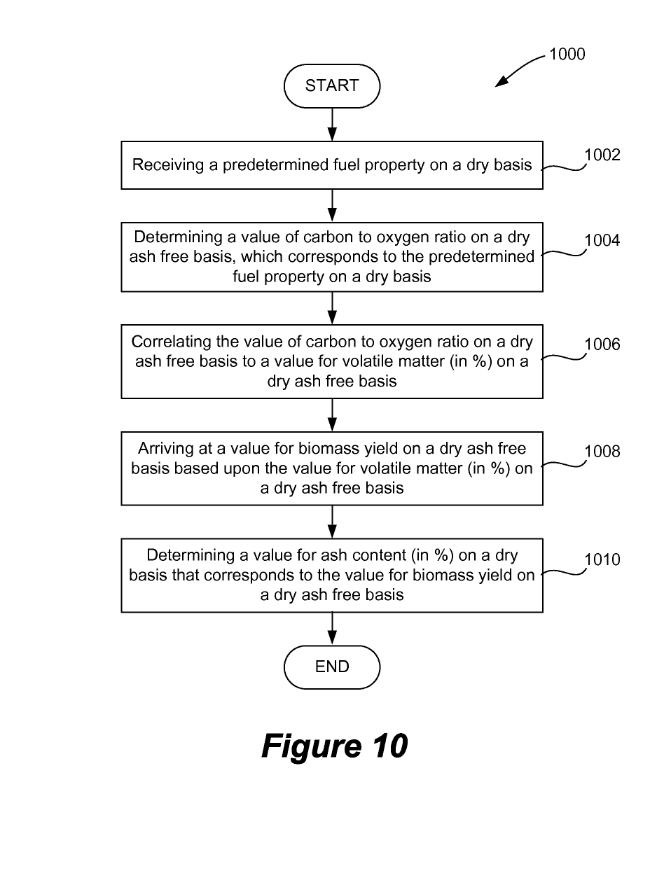

Correlations presented in Equations 7-12 of the present invention allow for determination of the ash content in the fuel based on one fuel property (e.g., HHV), which is typically provided on a dry basis by a Fuel Customer 106 of FIG. 1. To this end, FIG. 10 shows a flowchart for a process 1000 to determine a value for ash content on a dry basis based on a specified fuel property, such as HHV_{dry}.

A step 1002 includes receiving a predetermined fuel property on a dry basis. By way of example, a specific value for HHV_{dry} is received from a fuel customer. In other words, a fuel customer may place a request for purchasing a fuel having a particular value of HHV_{dry}.

Next, a step 1004 includes determining a value of C/O. Continuing with the above example of a request for a specified value of HHV_{dry}, Equation 9 is used to determine a corresponding value of C/O.

Then a step 1006 involves correlating a value of C/O to a value for VM_{DAF}. According to this step, a value for VM_{DAF} may be determined from a value of C/O using Equation 10.

A step 1008 includes arriving at a value for (M/M₀)_{DAF} based upon a value of VM_{DAF} obtained from step 1006. In this step, (M/M₀)_{DAF} may be determined from the value of VM_{DAF} using Equation 11.

A step 1010 includes determining a value for ash content on a dry basis (A_{dry}) that corresponds to the value for (M/M₀)_{DAF} from step 1008. By way of example, a value for A_{dry} is determined from a value of (M/M₀)_{DAF} using Equation 12.

The present invention recognizes that after A_{dry} is determined (i.e., ash content of the fuel is known), then bridge equations (i.e., Equations 13-19 presented below) may be used to convert fuel properties from the DAF regime back to the dry regime. Equations 13-19 are thought of as “bridge equations” because, as explained below, they serve as a bridge between the dry regime and the DAF regime, and vice versa. As mentioned above, fuel specifications are provided in and transactions for purchase of fuel are carried out in the dry basis regime, where various fuel properties simply do not correlate. According to the present invention, fuel properties enjoy strong correlations in the DAF regime. As a result, the bridge equations allow conversion of a specified fuel property, typically desired by a Fuel Customer 106 of FIG. 1, from a dry regime to a DAF regime, where fuel properties enjoy strong correlations (e.g., Equations 1-12), as advanced by the present invention, to compute at least one other fuel property in the DAF regime. One or more of the bridge equations allows conversion of the at least one other computed fuel property in the DAF regime back to the dry regime.

The bridge equations of the present invention include:

$$\begin{matrix}{HHV}_{dry} = {HHV}_{DAF} \frac{( 100 - {A}_{dry} )}{100} & ( Equation 13 ) \\ {FC}_{dry} = {FC}_{DAF} \frac{( 100 - {A}_{dry} )}{100} & ( Equation 14 ) \\ {VM}_{dry} = {VM}_{DAF} \frac{( 100 - {A}_{dry} )}{100} & ( Equation 15 ) \\ {C}_{dry} = {C}_{DAF} \frac{( 100 - {A}_{dry} )}{100} & ( Equation 16 ) \\ {H}_{dry} = {H}_{DAF} \frac{( 100 - {A}_{dry} )}{100} & ( Equation 17 ) \\ {O}_{dry} = {O}_{DAF} \frac{( 100 - {A}_{dry} )}{100} & ( Equation 18 ) \\ {( \frac{M}{{M}_{o}} )}_{dry} = {( \frac{M}{{M}_{o}} )}_{DAF} * \frac{( 100 - {A}_{0 , dry} )}{( 100 - {A}_{dry} )} & ( Equation 19 )\end{matrix}$$

Equation 13 expresses a relationship that allows computing HHV_{dry} from HHV_{DAF}, and vice versa. Equation 14 is directed to fixed carbon (“FC”) and expresses a relationship that allows computing FC_{dry} from FC_{DAF}, and vice versa. As a side note, immediately after biomass is processed to fuel, typically there are negligible amounts of, or no, moisture left. In the DAF regime, therefore, as a practical matter, the following equation holds true:

VM_{DAF}+FC_{DAF}=100 (Equation 20)

Thus, FC_{DAF} is easily calculated from VM_{DAF}.

According to Equation 15, VM_{dry} may also be calculated from VM_{DAF}, and vice versa. Equations 16-19 similarly provide relationships for carbon, hydrogen, oxygen and mass yield such that their values in the dry regime can be obtained from their values in the DAF regime, and vice versa.

Although process 1000 is explained using an example in which a fuel customer places a request for a desired value of HHV_{dry}, those skilled in the art will appreciate that at least some of Equations 7-19 may similarly be used to arrive at A_{dry}, if the customer requests fuel having specific values of one or more of other fuel properties (e.g., FC_{dry}, VM_{dry}, C_{dry}, H_{dry}, O_{dry} or (M/Mₒ)_{dry}).

According to certain preferred embodiments of the present invention and with reference to FIG. 1, Fuel Production Management Facility 104 obtains from Biomass-Based Fuel Production Plant 102 a value for an amount of initial ash content of biomass on a dry basis (A_{o,dry}) and serves to guide Biomass-Based Fuel Production Plant 102 to produce biomass-based fuel for sale. In this embodiment, Fuel Production Management Facility 104 receives a request from Fuel Customer 106 regarding a request to purchase fuel having a predetermined value of a fuel property on a dry basis (e.g., FC_{dry}, VM_{dry}, C_{dry}, H_{dry}, O_{dry} or (M/Mₒ)_{dry}). To meet the purchase request, Fuel Production Management Facility 104 may convey to Biomass-Based Fuel Production Plant 102 or, in the alternative, compute for their own benefit one value of another fuel property on a dry basis because such value of another property provides insight into the manner in which the available biomass should be processed to meet the particular needs of Fuel Customer 106. As mentioned above to compute one other value of fuel on a dry basis, ash content of fuel on a dry basis (A_{dry}) is preferably first determined. To this end, Fuel Production Management Facility 104 may compute A_{dry} using the known value of A_{o,dry}, the specified or predetermined value of a fuel property and by solving at least one equation from a first set of equations and at least one equation from a second set of equations. The first set of equations includes Equations 13-19 and the second set of equations includes Equations 4-8 and 11-12.

In accordance with one embodiment, the value of A_{dry} computed according to the present invention is conveyed to Biomass-Based Fuel Production Plant 102 for facilitating processing of biomass or to Fuel Customer 106 for facilitating combustion of fuel. In preferred embodiments of the present invention, the value of A_{dry} is conveyed to Biomass-Based Fuel Production Plant 102 for processing of biomass to produce fuel or to Fuel Customer 106 for combusting the ultimately produced fuel. In those embodiments, where A_{dry} is conveyed for biomass processing, preferably thermo-chemical processing in a torrefaction chamber is carried out. In preferred embodiments of the present invention, GCF 1300 Inert Gas Furnace, which is commercially available from Across International of Berkeley Heights, N.J., is used.

According to other preferred embodiments of the present invention, Fuel Production Management Facility 104 obtains from Biomass-Based Fuel Production Plant 102 a value for an amount of initial ash content of biomass on a dry basis (A_{o,dry}) and serves to guide Biomass-Based Fuel Production Plant 102 to produce biomass-based fuel for sale. In this embodiment, Fuel Production Management Facility 104 receives a request from Fuel Customer 106 regarding a request to purchase fuel having a predetermined or, in the alternative, specified ash content (A_{dry}). To meet the purchase request, Fuel Production Management Facility 104 may convey to Biomass-Based Fuel Production Plant 102, or in the alternative, compute for its own benefit one value of another fuel property on a dry basis because such value of another fuel property provides insight into the manner in which the available biomass may be processed to meet the particular needs of Fuel Customer 106. To this end, Fuel Production Management Facility 104 may compute a value of the other fuel property by solving Equation 7, and by solving at least one equation from a first set of equations and at least one equation from a second set of equations. The first set of equations in this embodiment includes Equations 4-8 and 11-12, and the second set of equations includes Equations 13-19.

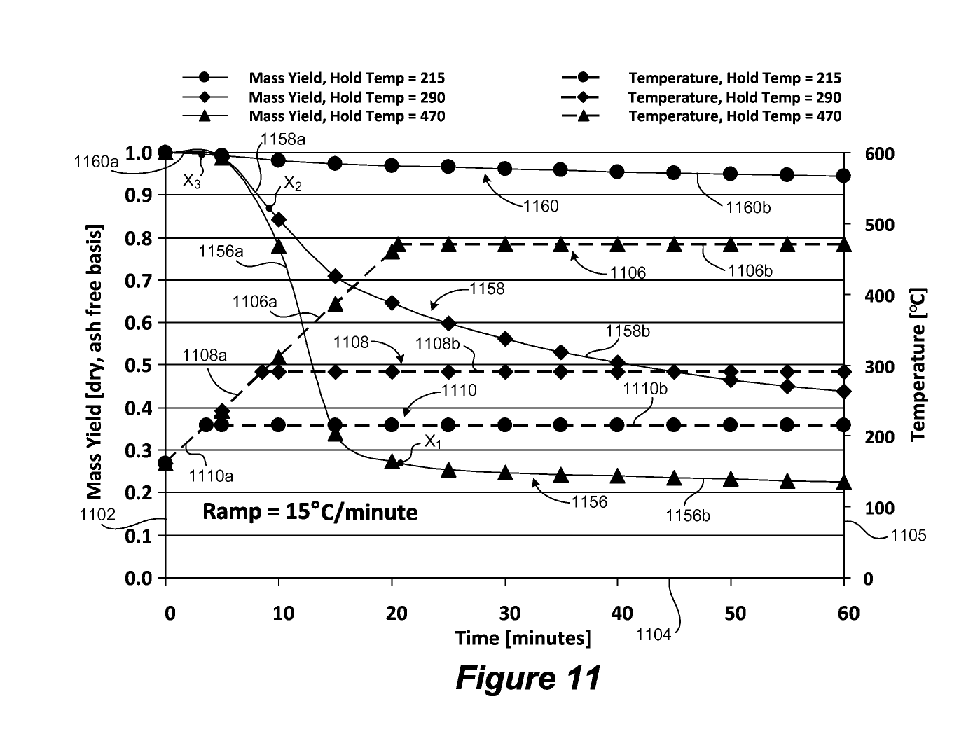

FIG. 11 shows a graph where values for (M/Mₒ)_{DAF} are plotted on a first Y-axis (denoted by 1102) and values for temperature of biomass undergoing processing are plotted on a second Y-axis (denoted by 1105) against values for time of biomass processing that are plotted on an X-axis (denoted by 1104). Units for time of biomass processing are expressed in minutes and for temperature of biomass undergoing processing are expressed in degrees Celsius (° C.). According to the present invention, the graph shown in FIG. 11 is prepared for each type of biomass that is used to produce fuel and prepared for each value of temperature ramp rate. Temperature ramp rate, as that term is used in this specification, refers to the rate of change in temperature of biomass during processing per unit time of biomass processing. FIG. 11 shows hydro-mechanically treated rice straw having an average particle size of 0.12 mm, at a temperature ramp rate of 15° C./minute. The values for mass yield are obtained in the same manner as described with reference to FIG. 4A and values for time and temperature were obtained by conducting torrefaction experiments SII Seiko TG/DTA EXSTAR 6300 instrument, commercially available from Seiko instruments, Inc. of Chiba, Chiba, Japan.

During biomass processing, as temperature of biomass undergoing processing changes over a period of time, so does a fuel property, e.g., (M/Mₒ)_{DAF}, as shown in FIG. 11. As a result, the change in temperature of the biomass undergoing processing can be thought to have a corresponding relationship to a fuel property. To this end, FIG. 11 shows three temperature plots 1106, 1108 and 1110, which correspond to three fuel property plots 1156, 1158 and 1160, respectively.

Each temperature plot has two regions, a ramp-rate region and an isothermal region. In the ramp-rate region shown in FIG. 11, the temperature of biomass processing increases at a ramp rate of 15° C./minute. In the isothermal region, the temperature of biomass undergoing processing is held at a constant predetermined temperature, often referred to as the “hold temperature.” For temperature plots 1106, 1108 and 1110, the hold temperatures are 215° C., 290° C. and 470° C., respectively.

Each temperature plot 1106, 1108 and 1110 includes a ramp-rate region 1106a, 1108a and 1110a, respectively, and an isothermal region 1106b, 1108b and 1110b, respectively. In other words, during biomass processing, as shown in FIG. 11, biomass is treated for a first period of time under temperature ramp-rate conditions and for a second period of time under isothermal conditions. Accordingly, a correlation between a fuel property and time is different in the ramp-rate region than in the isothermal region.

Likewise, each fuel property plot 1156, 1158 and 1160 includes a ramp-rate corresponding region 1156a, 1158a and 1160a, respectively, and an isothermal corresponding region 1156b, 1158b and 1160b, respectively. Locations denoted by X₁, X₂ and X₃, on fuel property plots 1156, 1158 and 1160, respectively, show the boundaries between the ramp-rate corresponding regions and the isothermal corresponding regions. Thus, regions 1156a, 1158a and 1160a correspond to ramp-rate regions 1106a, 1108a and 1110a, and regions 1156b, 1158b and 1160b correspond to isothermal regions 1106a, 1108a and 1110a, respectively.

To illustrate one advantage of the present invention, each of X₁, X₂ and X₃ shows a value of time on the fuel property plots where a hold temperature is first realized and held through the isothermal region. By way of example, a hold temperature of 470° C. is first realized at location X₁ on fuel property curve 1106, a hold temperature of 290° C. is first realized at location X₂ on fuel property curve 1108, and a hold temperature of 215° C. is first realized at location X₃ on fuel property curve 1110.

The present invention recognizes that in the isothermal region, a fuel property value typically changes in a gradual, tapered fashion. In sharp contrast, for a constant value of a temperature ramp rate, an increase in a value for a hold temperature (which in this case is the same as an increase in the duration of the ramp rate), results in a drastic biomass weight loss, i.e., proportionately increased conversion of biomass to fuel. By way of example, at any given time during ramp-rate period 1156a, a value for biomass weight loss on plot 1156 (where hold temperature is 490° C.) is greater than a value for biomass weight loss on plot 1158 (where hold temperature is 290° C.), which is in turn greater than a value for biomass weight loss on plot 1160 (where hold temperature is 215° C.). In other words, the longer biomass is treated at a particular ramp rate, a higher amount of biomass is converted to fuel. Although FIG. 11 shows the effect of hold temperatures at a particular ramp rate on biomass weight loss, those skilled in the art will recognize that other fuel properties described herein will drastically change in a similar manner.

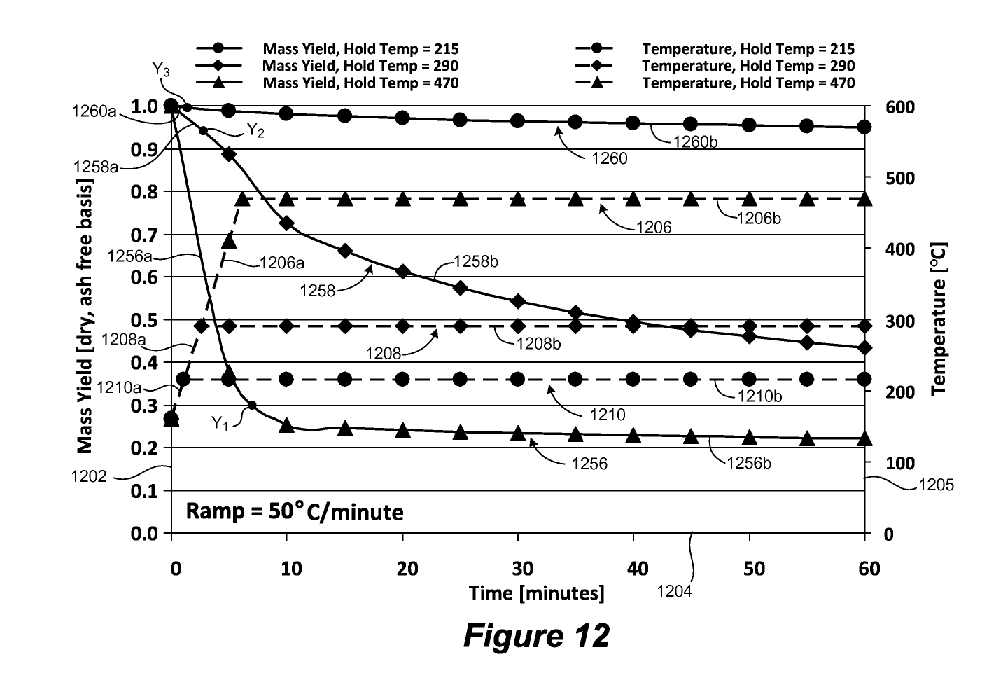

FIG. 12 shows various plots at a temperature ramp rate of 50° C./minute (as opposed to 15° C./minute shown in FIG. 11). Features 1202, 1204, 1205, 1206, 1206a, 1206b, 1208, 1208a, 1208b, 1210, 1210a, 1210b, 1256, 1256a, 1256b, 1258, 1258a, 1258b, 1260, 1260a, 1260b, Y₁, Y₂ and Y₃ shown in FIG. 12 are similar to their counterparts (i.e., 1102, 1104, 1105, 1106, 1106a, 1106b, 1108, 1108a, 1108b, 1110, 1110a, 1110b, 1156, 1156a, 1156b, 1158, 1158a, 1158b, 1160, 1160a, 1160b, X₁, X₂ and X₃) shown in FIG. 11. Furthermore, the correlations in FIGS. 11 and 12 are developed for the same type of biomass.

A comparison of FIGS. 11 and 12 shows that a higher biomass weight loss (i.e., a higher conversion of biomass to fuel) is realized for higher values of temperature ramp rates. At a ramp rate of 15° C./minute (shown in FIG. 11), a biomass weight loss of about 73% is realized after processing the biomass for about 20 minutes. Comparatively, at a ramp rate of 50° C./minute (shown in FIG. 12), about the same amount of biomass weight loss is realized after processing the biomass for about 7 or 8 minutes. Thus, the present invention establishes that when the same type of biomass is used, a much higher throughput for fuel production is realized at higher ramp rates during the ramp-rate period.

In a preferred embodiment of the present invention, the correlations set forth in FIG. 11 are used to obtain a process parameter in the ramp-rate region. The present invention recognizes that during a process of torrefaction, knowledge of process parameters such as temperature of ramp rate, time of biomass processing, and temperature of biomass undergoing processing are useful for converting biomass into fuel. By way of example, if one process parameter and one fuel property are known for a given type of biomass, the correlations set forth in the ramp-rate region of FIG. 11 are used to determine the remaining process parameters. It is noteworthy that in the ramp-rate region, the process parameters, i.e., temperature ramp rate, time of biomass processing, and temperature of biomass, satisfy the following expression:

T=Tₒ+(rt)/60 (Equation 21)

wherein T represents a value of temperature of biomass, Tₒ represents a value of initial temperature of biomass before processing, r represents a value of temperature ramp rate of biomass during processing, and t represents an amount of time of processing biomass.

Knowledge of one such process parameter allows calculation of the remaining process parameters and, thereby facilitates conversion of biomass into fuel. If a fuel customer, e.g., Fuel Customer 106 of FIG. 1, provides a desired value for a fuel property on a dry basis, then bridge equations, i.e., Equations 13-19, are used to convert those values to a DAF basis so that it is ultimately used in conjunction with correlations of FIG. 11 to calculate process parameters, as mentioned above.

In preferred embodiments of the present invention, the correlations shown in FIG. 11 or 12 are used to calculate a fuel property when certain process parameters are known in the ramp-rate region. By way of example, for a given type of biomass in the ramp-rate region, if a value for temperature ramp rate of biomass undergoing processing and a value for time of biomass processing or temperature of biomass are known, then a value for a fuel property on a DAF basis is calculated. Furthermore, a value of another fuel property on a DAF basis may be calculated from the above fuel property on a DAF basis by using a value for A_{o,dry}, obtained as mentioned above, and relevant one(s) of Equations 4-8 and 12. The calculated value of another fuel property on a DAF basis may be converted to a value on a dry basis using bridge equations, i.e., Equations 13-19.

Typically, knowledge of two fuel properties is important during conversion of biomass to fuel. By way of example, a fuel customer, e.g., Fuel Customer 106, commonly specifies an amount of fuel required (which correlates to (M/Mₒ)_{dry}) and HHV_{dry} when purchasing fuel. In this instance, the above-described techniques ensure that proper settings of process parameters (e.g., at Biomass-Based Fuel Production Plant 102 of FIG. 1) are implemented to obtain a fuel of desired properties.

In a preferred embodiment of the present invention, the correlations set forth in FIG. 11 or 12 are used to arrive at parameters required for processing in the isothermal region. The present invention recognizes that during a process of torrefaction, knowledge of values for at least two process parameters and one fuel property (typically provided by a fuel customer) for a given type of biomass, allows for calculation of the remaining process parameter.

In other preferred embodiments of the present invention, the correlations shown in FIG. 11 or 12 are used to calculate a fuel property when the process parameters are known in the isothermal region. As explained above in connection with the ramp-rate region, other fuel properties, either on a DAF basis or on a dry basis, may also be determined to satisfy a fuel customer's demands.

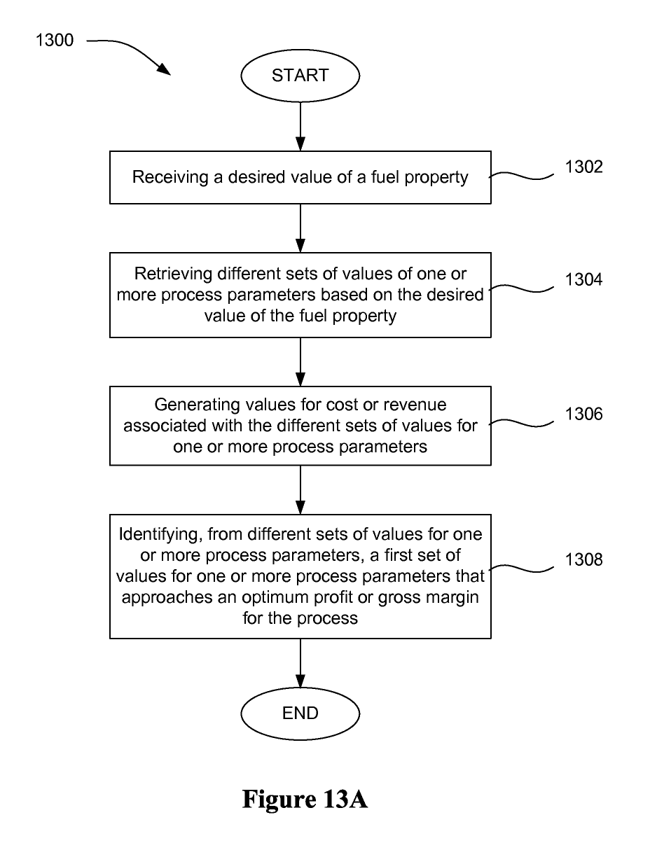

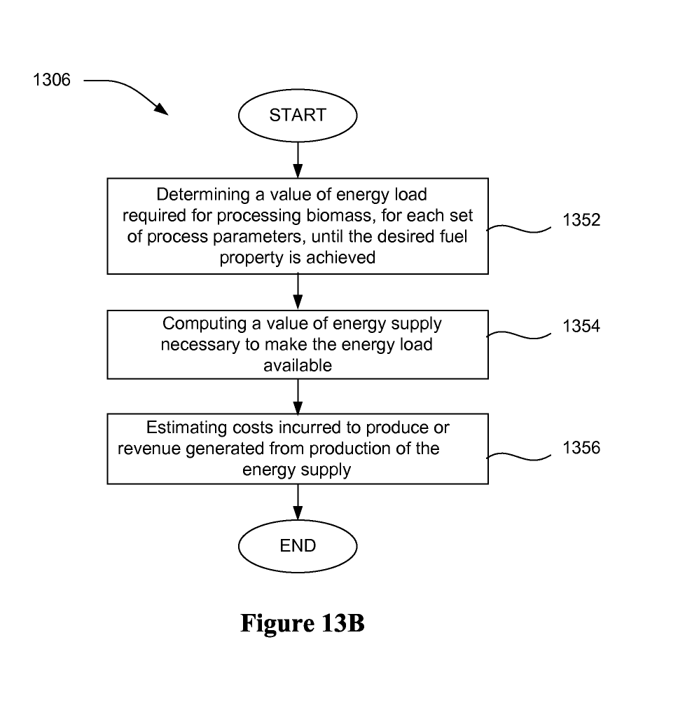

FIG. 13A is a flowchart showing certain salient steps for a process 1300, according to one embodiment of the present invention, of producing fuel using biomass. Process 1300 is based on one or more sets of process parameters, one of which yields optimum values of profit and/or gross margin for the fuel production process. In preferred embodiments of the present invention, the process of converting biomass to fuel is a thermo-chemical process.

Process 1300 begins with a step 1302 of receiving a desired value of a fuel property, e.g., higher heating value, volatile matter, fixed carbon, carbon content, oxygen content, hydrogen content, and initial ash content, preferably on a dry basis. In certain embodiments, the value of a desired fuel property is received from a fuel customer, such as fuel customer 106 of FIG. 1. Preferably, the value of the fuel property is correlated to a value of mass yield on a dry basis, as explained above with reference to FIGS. 4A, 4B, and 5-9, and Equations 1-20.

Next, a step 1304 of retrieving different sets of values of one or more process parameters based on the desired value of the fuel property is carried out. Preferably, the sets of values of one or more process parameters include a value of a hold temperature of biomass during biomass processing, a value of time of biomass processing, and a value of temperature ramp-rate during biomass processing. In alternate embodiments, sets of values of one or more process parameters may include a value of temperature inside a reactor that carries out a thermochemical process, and a value of line speed of biomass traversing a dimension of a thermochemical reactor. In preferred embodiments of the present invention, each of the different sets of values of one or more process parameters are retrieved in the manner explained above with reference to FIGS. 11 and 12.

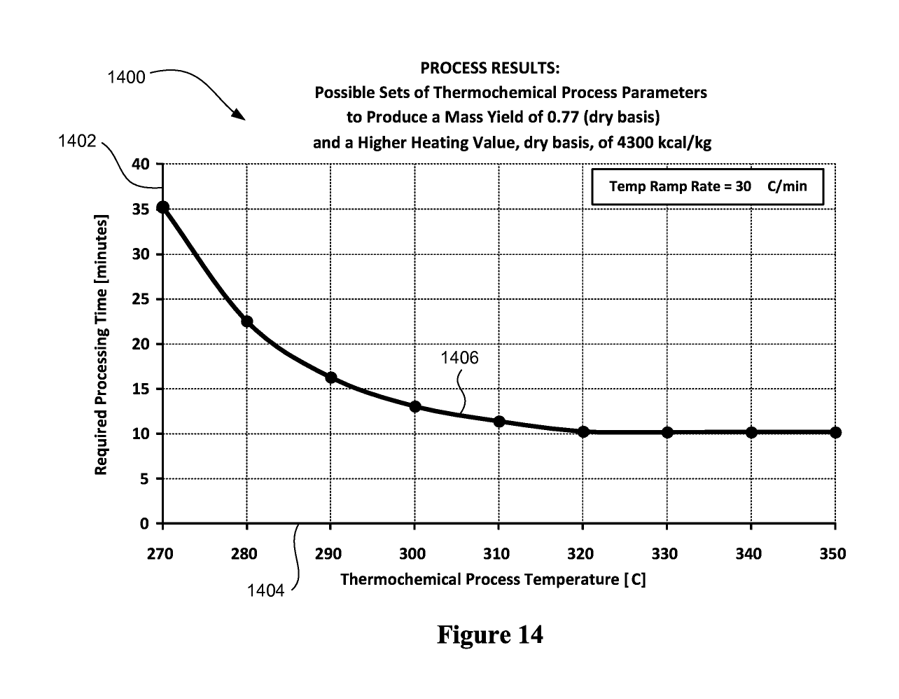

By way of example, FIG. 14 shows a graph 1400 where multiple different sets of values of process parameters are plotted to generate a plot 1406. In graph 1400, values for a time of biomass processing (having units of minutes) are plotted along a Y-axis 1402, and values for a hold temperature of biomass during biomass processing (having units of ° C.) are plotted on an X-axis 1404. In FIG. 14, for various values of time of biomass processing and hold temperature of biomass, temperature ramp-rate is about 30° C./min. The present invention realizes that multiple different sets values of time of biomass processing and hold temperature of biomass may be similarly generated for different values of temperature ramp rate (e.g., 5° C./min, 15° C./min and 50° C./min).

Next, for each different sets of values of one or more process parameters, a step 1306 of generating associated values of cost or revenue is carried out. Values of cost may include any cost associated with biomass processing. Examples of such values of cost are discussed below with reference to certain preferred embodiments of the present invention. Values of revenue may be calculated according to methods well-known to those skilled in the art. In certain embodiments of the present invention, specific methods of calculating revenue are contemplated and are described below in greater detail.

Next, a next step 1308 of identifying, from different sets of values of one or more process parameters, a first set of values of one or more process parameters that approaches an optimum value of profit or gross margin for the biomass-fuel production process. A value of profit is preferably determined according to the following equation:

Profit=Revenue−Cost (Equation 22)

In step 1308 of FIG. 13A a value of gross margin may be determined according to an equation:

Gross Margin=(Revenue−Cost)/Revenue (Equation 23)

At the conclusion of step 1308, multiple values of profit or gross margin are available and each of these values is based on a particular set of process parameter values. In one embodiment of the present invention, from these multiple values of profit and gross margin, a largest value of profit or gross margin is identified. In alternate embodiments of the present invention, a value of profit or gross margin that approaches an optimum is identified. Regardless of whether a maximum value or a value that approaches an optimum value of profit or gross margin are identified in step 1308, the underlying values of a set of process parameters that provide the desired value (i.e., maximum or approaching optimum value) of profit or gross margin are known from step 1304. From an economic point of view, the present invention preferably includes a step (after step 1308) of processing biomass at values of process parameters identified in step 1304 that produce a desired value of profit or gross margin. In this manner, the teachings of the present invention are used to accomplish a desired economic outcome for the fuel production process.

FIG. 13B is a flowchart showing certain detailed steps, according to one embodiment of the present invention, underlying step 1306 of FIG. 13A. According to FIG. 13B, process 1306 begins with a step 1352, which involves determining a value of energy load required for processing biomass, for each set of process parameters, e.g., the sets of process parameters plotted on curve 1406 of FIG. 4. The energy load refers to the amount of energy, per unit time, required to heat and dry biomass during biomass processing.

Next, a step 1354 includes identifying a required value of energy that provides an amount of energy necessary for producing a given value of energy load. The present invention recognizes that due to energy losses and irreversibilities inherent to any thermochemical system or process, input of energy supply is greater than energy load. This ensures that a requisite amount of energy for drying and heating biomass to completion during biomass processing is available. Step 1354 includes computing a value of energy supply. In preferred embodiments of the present invention, energy supply is calculated according to the following expression:

$$η = \frac{{E}_{load}}{{E}_{supply}} \qquad ( Equation 24 )$$

where E_{load} represents a value of energy load, per unit time, E_{supply} represents a value of energy supply, per unit time, necessary to provide E_{load} to a biomass processing system or process, and η represents a value of efficiency for the biomass processing system or process. In those embodiments where a thermochemical processing system is implemented to produce fuel, η is equal to ηₜₕₑᵣₘ, which represents a value of the thermochemical efficiency of a biomass processing system or process. Value of η or ηₜₕₑᵣₘ depends upon such factors as values of process parameters (e.g., values of process parameters plotted on curve 1406 of FIG. 14), or amount of biomass that undergoes processing. As a result, those skilled in the art may employ conventional techniques to determine an actual or estimated value of η or ηₜₕₑᵣₘ in advance of biomass processing. In implementing conventional techniques to determine η or ηₜₕₑᵣₘ, those skilled in the art may choose to rely upon historical information regarding values of η or ηₜₕₑᵣₘ.

Next, a step 1356 is carried out to estimate the costs incurred to produce E_{supply} or revenue generated from production of E_{supply}. A value of cost is preferably determined according to the following equation:

C_{supply}=E_{supply}*P_{energy} (Equation 25)

where C_{supply} represents a value of cost, per unit time, of total energy supply, preferably fuel, associated with a set of values of process parameters, and P_{energy} represents a value of price per unit of energy, preferably fuel, available in the open market.

In step 1356, a value of revenue may also be calculated. The value of revenue is based on a set of values of process parameters for processing biomass and is generated according to the following equation:

Revenue=M_{fuel product}*P_{product} (Equation 26)

where M_{fuel product} represents an amount of fuel mass, on a dry basis, after biomass processing, and P_{product} represents a value of the sale price of said fuel mass on a per unit mass basis.

Step 1356 provides multiple values of cost or revenue, some of which are based on a particular set of process parameter values. According to certain preferred embodiments of the present invention, multiple values of cost or revenue are used to calculate multiple values of gross revenue or profit, from which optimal values, as described above with reference to step 1308 of FIG. 13A, are identified.

The present invention recognizes that different sets of values of process parameters, e.g., those plotted on plot 1406 of FIG. 14, have different energy requirements, and accordingly, different cost requirements. By identifying optimal values for profit or gross margin, the process parameters underlying these optimal values are also identified.

The present invention contemplates numerous different ways of implementing step 1306 of FIG. 13A. To this end, the steps shown in FIG. 13B may also be carried out using different techniques. By way of example, the present invention recognizes that a value for E_{load}, as explained in step 1352 of FIG. 13B, represents a sum of energy, per unit time, required to dry biomass (“E_{drying}”), and energy, per unit time, required to heat biomass to a processing temperature (“E_{heating}”). Preferably, a value of E_{load} is calculated according to the following equation:

E_{load}=E_{drying}+E_{heating} (Equation 27)

Next, in this embodiment, step 1354 of FIG. 13B involves computing a value of E_{supply}, as explained by Equation 24. After determining a value of E_{supply}, a step 1356 in this embodiment involves computing the cost associated with providing E_{supply}, on a per unit time basis, according to the following equation:

C_{supply}=E_{supply}*P_{energy} (Equation 28)

where C_{supply} refers to a value of cost, per unit time, associated with providing E_{supply}, and P_{energy} is a value of cost of energy, preferably fuel, on a per unit time basis.

The present invention recognizes that there may be different ways of computing E_{load}, as is required by step 1352 of FIG. 13B. In preferred embodiments of the present invention, calculation of E_{load} begins with determining an amount of biomass (on a dry basis), per unit time, that is expected to undergo processing. The amount of biomass, per unit time, is calculated based on values of certain process parameters (e.g., values of biomass processing time provided in FIG. 14) and according to the following equation:

$${M}_{0 , biomass , dry} = \frac{{m}_{biomass}^{m} * ( \frac{100 - \% {M}_{after drying }}{100} ) * {V}_{reactor} -}{{t}_{res}} \qquad ( Equation 29 )$$

where M_{0,biomass,dry} represents a value of the amount of biomass, on a dry basis, to be processed per unit time; [symbol] _{reactor} represents a value of a volumetric size of a thermochemical reactor to be used during processing of biomass; m_{biomass}^{m} represents a value or an estimated value of an amount of biomass, on an as-received basis, per unit volume in the thermochemical reactor; tᵣₑₛ represents a value of time of thermochemical processing of biomass; and % M_{after drying} represents a value or an estimated value of a moisture percentage remaining in the biomass after any pre-biomass-processing drying treatment and before any thermochemical processing. With respect to pre-biomass-processing drying treatment, biomass is typically dried (preferably in a rotary dryer) after a leaching step and before thermochemical processing, according to preferred embodiments of the present invention. Leaching produces biomass having a moisture percentage of about 50% or greater. After the pre-biomass-processing drying treatment, however, the moisture percentage in the biomass reduces to value that is between about 5% and about 15%.

After M_{0,biomass,dry} is known, a value of E_{drying} is preferably calculated by the following equation:

$$\frac{{E}_{drying}}{{M}_{0 , biomass , dry}} = ( \frac{\% {M}_{before drying }}{100 - \% {M}_{before drying }} ) {\int }_{{t}_{amb}}^{100 ° C .} {Cp}_{{H}_{2} O ( 1 )} d T + ( \frac{\% {M}_{before drying }}{100 - \% {M}_{before drying }} ) * {H}_{{H}_{2} O , fg} \qquad ( Equation 30 )$$

### (Equation 30)

Where % M_{before drying} represents a value or an estimated value of a moisture percentage in biomass before any drying of biomass; Cp_{H}_{₂}_{O(l)} represents a value of a specific heat capacity of liquid water; H_{H}_{₂}_{O,fg} represents a value of latent heat of vaporization of water; and T_{amb} represents a value of ambient temperature or initial temperature of biomass before processing.

Next, E_{heating} is preferably calculated according to the following equation:

$$\frac{{E}_{heating}}{{M}_{0 , biomass , dry}} = {\int }_{{T}_{amb}}^{Thold} [ \frac{{M}_{fuel product}}{{M}_{0 , biomass , dry}} {Cp}_{biomass} + ( 1 - \frac{{M}_{fuel product}}{{M}_{0 , biomass , dry}} ) {Cp}_{vgas} ] d T \qquad ( Equation 31 )$$

where Cp_{biomass} represents a value of the specific heat of biomass being processed; Cp_{vgas} represents a value of the specific heat of volatile gases expected to be emitted during biomass processing; T_{hold} is a value of the hold temperature of biomass during the processing; and T refers to an instantaneous value of temperature.

The present invention recognizes that because torrefaction is a slightly exothermic process, once a hold temperature is achieved during biomass processing, a relatively small amount of energy may be necessary to maintain biomass at that hold temperature. As a result, the extra energy needed to maintain the biomass at the hold temperature is not included in Equation 31. However, those skilled in the art will appreciate that in certain embodiments of the present invention, such extra energy is accounted for when computing E_{heating}.

After calculating E_{load} using Equations 27-31, E_{supply} may be computed using Equation 24, as required by step 1356 of FIG. 13B. Next, values of costs or revenue required by step 1356 are computed to ultimately provide values for profit or gross margin (see step 1308 of FIG. 13A).

Like E_{load}, values of cost as required by step 1356 of FIG. 13B may be computed in many different ways. In one preferred embodiment of the present invention, values of cost account for a value for E_{electric}, which represents an amount of energy, per unit time, associated with electrical costs for moving and preparing materials necessary for the operation of a biomass-fuel production system, including a thermochemical system. By way of example, augers and conveyors (which move biomass to and from dryers and reactors), blowers (which supply hot process gases for the drying and heating systems), fans (which remove volatile gases resulting from biomass processing), require electrical power. Furthermore, steps of milling and chopping biomass before processing also require significant electrical input.

Cost associated with providing E_{electric}, on per unit time basis, is calculated according to the following equation:

C_{electric}=E_{electric}*P_{electricity} (Equation 32)

where C_{electric} refers to a value of cost, per unit time, associated with providing E_{electric}, and P_{electricity} is a value of cost of energy, preferably electricity, on a per unit time basis.

In another preferred embodiment of the present invention, other costs associated with processing biomass are taken into account. By way of example, the present invention recognizes that processing biomass may have a unit price associated with the collection or procurement of biomass. The overall cost of biomass, represented by C_{biomass}, can be determined according to the following equation:

C_{biomass}=M_{0,biomass,dry}*P_{biomass} (Equation 33)

where M_{0,biomass,dry} represents a value of the amount of biomass, on a dry basis, expected to undergo processing per unit time, and P_{biomass} represents a value of the per-unit price of biomass.

In yet another preferred embodiment of the present invention, running the thermochemical system includes miscellaneous variable costs C_{variable,misc}. Such costs are considered variable because they vary according to the amount of biomass being processed, e.g., diesel fuel costs for operating front-end biomass loaders. A value of C_{variable,misc} is known or capable of being estimated by one skilled in the art using conventional techniques.

According to yet another preferred embodiment of the present invention, running the thermochemical system includes fixed costs, C_{fixed}, such as labor and overhead costs. Such costs are considered fixed because they are generally independent of the amount of biomass being processed, e.g., labor, costs necessary to fund a laboratory, and quality control. A value of C_{fixed} is known or capable of being estimated by one skilled in the art using conventional techniques. Based on these cost computations, values of profit or gross margin, as required by step 1308 of FIG. 13A, are calculated.

In certain other preferred embodiments of the present invention, a value of total cost, Cₜₒₜₐₗ, accounts for values of different costs discussed above and is calculated by the following expression:

Cₜₒₜₐₗ=C_{supply}+C_{electric}+C_{biomass}+C_{variable,misc}+C_{fixed} (Equation 34)

Such a comprehensive accounting of all the costs involved for transforming biomass to fuel may provide more accurate values for profit or gross margin. From these values of profit and gross margin, which are associated with different sets of values of process parameters, values of those process parameters that yield optimal values of profit or gross margin are identified.

FIG. 14 shows plot 1406 for fuel having an HHV of 4300 kcal/g that was obtained from thermochemical processing of rice straw having a value of an initial ash content of about 15% on a dry basis. Using Equations 7, 9, 10, 12 and 19 above, the mass yield is value of about 0.77 on a dry basis, and ash percentage of fuel is a value of about 19.5% on a dry basis. According to step 1304 of FIG. 13A, multiple values of process parameters connect to form plot 1406.

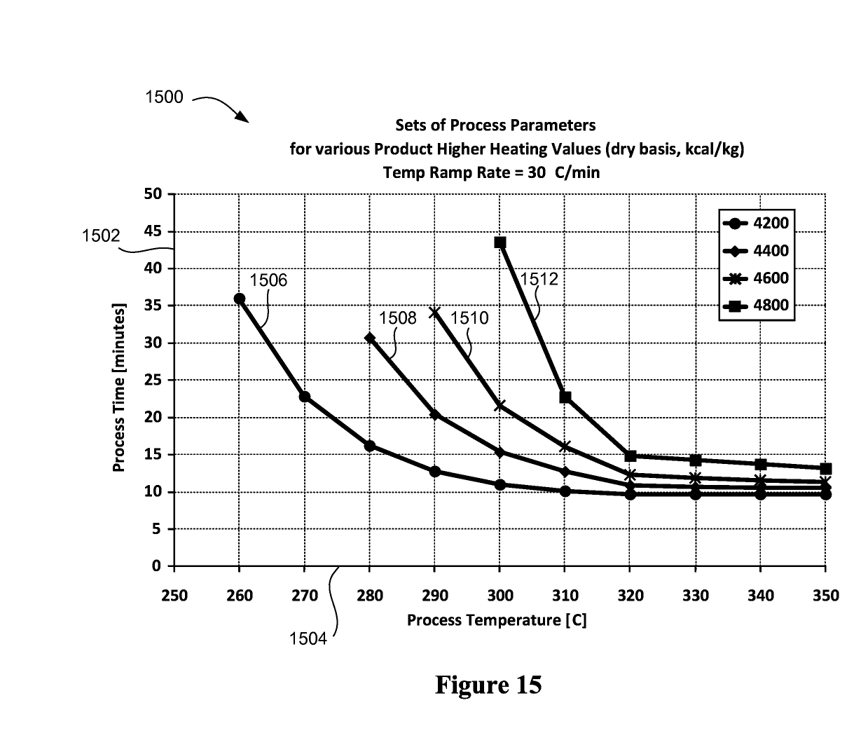

FIG. 15 shows a graph 1500 showing a separate plot for each of the different values of HHV for fuel that is ultimately produced according to inventive processes. Specifically, plots 1506, 1508, 1510 and 1512 are each associated with a fuel product having HHVs of 4200 kcal/kg, 4400 kcal/kg, 4600 kcal/kg and 4800 kcal/kg, on a dry basis, respectively, and corresponding values of mass yield of 0.84, 0.71, 0.60 and 0.50, on a dry basis, respectively. Each plot in FIG. 15 is created using different sets of values of process parameters, as described above with reference to plot 1406 of FIG. 14.

As shown in FIG. 15, each fuel product generated from processing biomass at the values of sets of process parameters associated with plots 1506, 1508, 1510 and 1512, has a different HHV. In preferred embodiments of the present invention, each fuel product is produced from a single type of biomass, e.g., rice straw, and therefore is associated with a specific, different value of mass yield.

For each value of HHV plotted in FIG. 15, an optimal value of profit or gross margin is preferably determined according to inventive methods described above with reference to FIGS. 13A, 13B or Equations 22-23.

FIG. 15 shows a general trend that to obtain a certain HHV value, higher biomass processing temperatures correlates to shorter biomass processing times. However, according to this figure, for each of the different HHV plots, beyond a certain value of biomass processing temperature (i.e., above 320° C.), the minimum time required for biomass processing no longer decreases to an appreciable extent. As a result, the amount of wasted energy is reduced in the case of each HHV plot when 320° C. is the highest operating temperature during biomass processing. Therefore, when determining values of optimal profit and gross margin for each HHV plot, it would not be necessary to calculate such values for settings where the processing temperature is greater than about 320° C.

In alternate embodiments of the present invention, each fuel product at the values of different sets of process parameters shown on FIG. 15 is associated with a single value of mass yield. In these embodiments, each fuel product is generated with different blends of one or more types of biomass to produce fuel with the desired fuel properties. By way of example, biomass used to generate fuel may be a blend of one or types of agro-waste, such as rice straw and sugar-cane leaves. The present invention recognizes that an optimum blend of agro-waste, e.g., ratio of an amount of rice straw to an amount of sugar-cane leaves, can be identified that will correspond to a set of values of process parameters, which will yield optimal values for profit or gross margin.

The present invention further recognizes that a similar process of determining an optimum value for each of different sets of process parameters may be carried out for more complicated costs and revenue analyses. Moreover, the present invention can be used to determine the most cost-effective fuel property values (e.g., one value of HHV selected from different values of HHV shown in FIG. 15) for a given type of biomass. Similarly, other physical metrics, such as minimum energy usage or maximum thermal efficiency, may be used as an alternate criterion to determine preferred sets of process parameters or desired values of particular fuel property (e.g., one value of HHV selected from different values of HVV shown in FIG. 15).

This description of the disclosed aspects of the present invention is provided to enable any person skilled in the art to make or use the present invention. Various modifications to these aspects will be readily apparent to those skilled in the art, and the generic principles defined herein may be applied to other aspects without departing from the spirit or scope of the invention. Moreover, having thus described the invention, it should be apparent that numerous structural modifications and adaptations may be resorted to without departing from the scope and fair meaning of various embodiments of the instant invention as set forth hereinabove and as described herein below by the claims.

What is claimed is:

1. A process for processing biomass, comprising:
receiving a predetermined value of a first property of a fuel that is derived from biomass;
retrieving a first different sets of values of one or more process parameters associated with a process that converts said biomass to said fuel, and said first different sets of values of said one or more said process parameters are based on said predetermined value of said first fuel property;
generating estimated values for cost or revenue associated with said first different sets of values of said one or more process parameters;
identifying, from said first different sets of values of said one or more process parameters, a first set of values of one or more process parameters that approaches an optimum profit or gross margin for said process; and
processing biomass near or at said first set of values of said one or more process parameters identified in said identifying.

2. The process of claim 1, wherein said generating includes:
determining a value of energy load required for processing biomass, for each said first different sets of values of said process parameters, to produce said fuel having said predetermined value of said fuel property;
computing a value of energy supply necessary to make available said value of said energy load; and
estimating costs incurred to produce said value of energy supply or revenue generated from production of said value of said energy supply.

3. The process of claim 1, wherein said generating said estimated values for cost includes generating values for at least one member selected from a group consisting of energy supply costs, electrical costs, fixed costs, variable costs, and biomass procurement costs.

4. The process of claim 2, wherein said determining said value of energy load required for processing biomass includes determining an amount of said biomass to undergo processing per unit time using an expression:
$${M}_{0 , biomass , dry} = \frac{{m}_{biomass}^{′″} * ( \frac{100 - \% {M}_{after drying }}{100} ) * {V}_{reactor} -}{{t}_{res}}$$
wherein said M_{0,biomass,dry} represents said value of said amount of said biomass, on a dry basis, to undergo processing per unit time during said processing biomass;
said _{reactor} represents a value for a volumetric size of a thermochemical reactor to be used during said processing biomass;
said m_{biomass}^{m} represents a value or an estimated amount of mass, per unit volume, of said biomass being processed in said thermochemical reactor;
said % M_{after drying} represents a value or an estimated value of a moisture percentage remaining in said biomass after a pre-biomass-processing drying treatment of said biomass is carried out before said processing biomass; and
said tᵣₑₛ represents a value for time of said processing biomass.

5. The process of claim 4 wherein said pre-biomass-processing drying treatment produces said biomass having a value for said moisture percentage that is between about 5% and about 15%.

6. The process of claim 4 wherein said pre-biomass-processing drying treatment is carried out using a rotary dryer.

7. The process of claim 4, wherein said determining said value of energy load includes determining a value of energy required for drying of said biomass or determining a value of energy required for heating said biomass after said drying of said biomass, to arrive at a hold temperature value during said processing biomass.

8. The process of claim 7, wherein said generating said value for said energy load includes solving an expression:
E_{load}=E_{drying}+E_{heating}
wherein said E_{load} represents said value for said energy load, per unit time required during said processing biomass;
said E_{drying} represents a value for said energy, per unit time, required for drying of said biomass that is performed during said processing biomass and required during a pre-biomass-processing drying treatment; and
said E_{heating} represents a value for said energy, per unit time, required for heating dry portion of said biomass and volatile gases released, during heating of said biomass, after said drying of said biomass to arrive at and maintain a hold temperature value during said processing biomass.

9. The process of claim 8, wherein said generating said value for E_{drying} includes solving an expression:
$$\frac{{E}_{drying}}{{M}_{0 , biomass , dry}} = ( \frac{\% {M}_{before drying }}{100 - \% {M}_{before drying }} ) {\int }_{{t}_{amb}}^{100 ° C .} {Cp}_{{H}_{2} O ( 1 )} d T + ( \frac{\% {M}_{before drying }}{100 - \% {M}_{before drying }} ) * {H}_{{H}_{2} O , fg}$$
wherein said M_{0,biomass,dry} represents said amount of said biomass, on a dry basis, to undergo processing per unit time;
said % M_{before drying} represents a value or an estimated value of a moisture percentage in said biomass before drying of said biomass during biomass processing;
said Cp_{H}_{₂}_{O(l)} represents a value of a specific heat capacity of liquid water;
said H_{H}_{₂}_{O,fg} represents a value of latent heat of vaporization of water; and
said T_{amb} represents a value of an ambient temperature or initial temperature of said biomass before performing said processing biomass.

10. The process of claim 8, wherein said generating said value for E_{heating} includes solving an expression:
$$\frac{{E}_{heating}}{{M}_{0 , biomass , dry}} = {\int }_{{T}_{amb}}^{Thold} [ \frac{{M}_{fuel product}}{{M}_{0 , biomass , dry}} {Cp}_{biomass} + ( 1 - \frac{{M}_{fuel product}}{{M}_{0 , biomass , dry}} ) {Cp}_{vgas} ] d T$$
wherein said M_{0,biomass,dry} represents said value of said amount of said biomass, on a dry basis, to undergo processing per unit time;
said M_{fuel product} represents an amount of fuel product, on a dry basis, to be obtained from said processing biomass;
said Cp_{vgas} represents a value for specific heat of volatile gases expected to be emitted during said processing biomass; and
said T represents said hold temperature value for said biomass during said processing biomass.

11. The process of claim 2, wherein said computing a value of energy supply necessary to make available said value of said energy load includes solving an expression:
$$η = \frac{{E}_{load}}{{E}_{supply}}$$
wherein said η represents a predetermined efficiency value for said processing biomass;
said E_{load} represents said value of said energy load, per unit time, of said biomass to be processed; and
said E_{supply} represents a value of said energy supply, per unit time, necessary to provide said E_{load} based on said η.

12. The process of claim 2, wherein said estimating costs incurred to produce said value of said energy supply, which is represented by C_{supply}, includes solving an expression:
C_{supply}=E_{supply}*P_{energy}
wherein said E_{supply} represents a value of said energy supply, per unit time, required for drying and heating biomass during said processing biomass; and
said P_{energy} represents a market price of a unit of said value of said energy supply.

13. The process of claim 1, wherein said generating estimated values for cost associated with said first different sets of values of said one or more process parameters includes solving an expression:
C_{electric}=E_{electric}*P_{electricity}
wherein said C_{electric} represents a value for cost, per unit time, associated with providing electrical energy required for carrying out said processing biomass and that does not include a value of cost for providing an amount of energy, per unit time, required for drying and heating performed during said processing biomass;
said E_{electric} represents a value of electric energy, per unit time, required for carrying out said processing biomass and that does not include said amount of energy, per unit mass of said biomass, required for drying and heating performed during said processing biomass; and
said P_{electricity} represents a market price of a unit of said value of E_{electric}.

14. The process of claim 1, wherein said generating estimated values for cost or revenue associated with said first different sets of values of said one or more process parameters includes solving an expression:
C_{biomass}=M_{0,biomass,dry}*P_{biomass}
wherein said C_{biomass} represents a value of cost, per unit time, associated with procurement of an amount of said biomass expected to undergo processing during said processing biomass;
said M_{0,biomass,dry} represents said value of said amount of said biomass, on a dry basis, to undergo processing per unit time during said processing biomass;
and said P_{biomass} represents a market price of a unit of biomass expected to undergo processing during said processing biomass.

15. The process of claim 2, wherein said generating estimated values for cost associated with said first different sets of values of said one or more process parameters includes solving an expression:
Cₜₒₜₐₗ=C_{supply}+C_{electric}+C_{biomass}+C_{variable,misc}+C_{fixed}
wherein said Cₜₒₜₐₗ represents a value of total cost, per unit time, associated with said processing biomass;
said C_{supply} represents a value of cost, per unit time, associated with providing said value of energy supply;
said C_{electric} represents a value for cost, per unit time, associated with providing electrical energy required for carrying out said processing biomass, but that does not include said C_{supply};
C_{biomass} represents a value of cost, per unit time, associated with procurement of said biomass during said processing biomass;
C_{variable,misc} represents a value of cost, per unit time, associated with said processing biomass that varies according to the amount of biomass processed during said processing biomass, but that does not include C_{supply}, C_{electric}, and C_{biomass}; and
C_{fixed} represents a value of cost, per unit time, associated with said processing biomass that is substantially fixed regardless of the amount of biomass processed during said processing biomass, but that is not included in C_{supply}, C_{electric}, and C_{biomass}.

16. The process of claim 1, wherein said biomass is at least one member selected from a group consisting of wood, guinea grass, rice straw, sugar cane leaves, cotton stalks, mustard stalks, pine needles, coffee husks, coconut husks, rice husks, mustard husks, weed straw, corn stover, sugar cane bagasse, millet stalks, pulses stalks, sweet sorghum stalks, nut shells, animal manure, guar husks, acacia totalis, Julia flora, jatropha residue, wild grass, pigeon beans, pearl millet, barley, dry chili, gran jowar, linseed, maize/corn, lentil, mung bean, sunflower, till, oil seed stalks, pulses/millets, black gram, sawan, soybean stalks, cow gram, horse gram, finger millet, turmeric, castor seed, meshta, sannhamp, and hemp.

17. The process of claim 1, wherein said receiving includes receiving said predetermined value of said first property of said fuel from a fuel customer.

18. The process of claim 1, wherein said first fuel property includes at least one member selected from a group consisting of higher heating value, mass yield, volatile matter, final ash content of fuel, fixed carbon, amount of carbon, amount of oxygen and amount of hydrogen.

19. The process of claim 1, wherein said value of said first fuel property is received on a dry basis.

20. The process of claim 1, wherein said one or more process parameters include at least one member selected from a group consisting of a duration of said process of converting said biomass to said fuel, said temperature of said biomass during said process, said temperature ramp rate of said biomass during said process, a temperature inside a reactor that carries out said process, and a line speed of biomass traversing a dimension of said reactor.

21. The process of claim 1, wherein said process of converting said biomass to said fuel is a thermo-chemical process.

22. The process of claim 1, wherein said generating includes generating values for said revenue using an expression that includes:
Revenue=M_{fuel product}*P_{product}
wherein said Revenue refers to said revenue, M_{fuel product} refers to amount of biomass, on a dry basis, and has units of mass, and P_{product} refers to market price of biomass per unit mass of said biomass.

23. The process of claim 2, wherein water is introduced during said process, and total energy costs include at least one member selected from a group consisting of cost of raising temperature of said biomass, cost of raising temperature of volatile gases produced during said process, cost of raising temperature of said water, and cost associated with the latent heat of water vapor resulting from evaporation of said water during said processing.

24. The process of claim 1, wherein in said identifying, said profit is determined using an expression that includes:
Profit=Revenue−Cₜₒₜₐₗ
wherein said Revenue refers to revenue and Cₜₒₜₐₗ refers to total cost associated with biomass processing.

25. The process of claim 1, wherein in said identifying, said gross margin is determined using an expression that includes:
Gross Margin=(Revenue−Cₜₒₜₐₗ)/Revenue
wherein said Revenue refers to revenue and said Cₜₒₜₐₗ refers to total cost associated with biomass processing.

26. The process of claim 1, further comprising:
obtaining additional values for a first property of said fuel;
retrieving additional of said first different sets of values for one or more process parameters associated with said process that converts said biomass to said fuel, and said additional of said first different sets of values for one or more said process parameters are based on said additional values of said first fuel property;
generating additional values for cost or revenue associated with each of said additional of said first different sets of values for one or more process parameters of said process;
identifying, from said first different set of values and additional values of said first different sets of values, an optimum set of values for one or more process parameters that approaches an optimum profit or gross margin for said process; and
processing biomass under said optimum set of values for one or more process parameters.

27. The process of claim 26, wherein said first fuel property is a property selected from a group consisting of mass yield, higher heating value, fixed carbon, volatile matter, carbon content, oxygen content, hydrogen content, and final ash content.

28. The process of claim 26, wherein said optimum set of values provides information regarding value of second fuel property that is identified to be optimum among different values of said second fuel property, each of which corresponds to said predetermined value of said fuel property or said additional values of said first fuel property.

29. The process of claim 26, wherein said biomass is a blended biomass, which includes more than one biomass type and said optimum set of values provides information regarding an amount of each biomass type present in said blended biomass.

30. The process of claim 26, wherein said obtaining different values for a second property of said fuel is carried out using said predetermined value of said first fuel property and said first different sets of values of said first fuel property.

31. A system for processing biomass, comprising:
means for receiving a predetermined value of a first property of a fuel that is derived from biomass;
means for retrieving a first different sets of values for one or more process parameters associated with a process that converts said biomass to said fuel, and said first different sets of values for one or more said process parameters are based on said predetermined value of said first fuel property;
means for generating values for cost or revenue associated with said first different sets of values for one or more process parameters of said process;
means for identifying, from said first different sets of values for one or more process parameters, a first set of values for one or more process parameters that approaches an optimum profit or gross margin for said process; and
means for processing biomass under said first set of values for one or more process parameters identified in said identifying.

32. The system of claim 31, wherein said means for generating includes a microprocessor.

33. The system of claim 31, wherein said process of converting said biomass to said fuel is carried out in a thermo-chemical reactor.

34. A system for facilitating production of fuel, said system comprising:
at least one processor;
at least one interface operable to provide a communication link to at least one network device; and
memory;
said at least one processor being operable to store in said memory a plurality of data structures;
said system being operable to:
obtain a predetermined value of a first property of a fuel that is derived from biomass;
retrieve a first different sets of values for one or more process parameters associated with a process that converts said biomass to said fuel, and said first different sets of values for one or more said process parameters are based on said predetermined value of said first fuel property;
generate values for cost or revenue associated with said first different sets of values for one or more process parameters of said process;
identify, from said first different sets of values for one or more process parameters, a first set of values for one or more process parameters that approaches an optimum profit or gross margin for said process; and
process biomass under said first set of values for one or more process parameters identified in said identifying.

35. The system of claim 34, wherein said processor is used to generate values for cost or revenue associated with said first different sets of values for one or more process parameters of said process.

36. The system of claim 34, wherein said process of converting said biomass to said fuel is carried out in a thermochemical reactor.
